(19) United States
(12) Patent Application Publication
(10) Pub. No.: US 2022/0017316 A1
(43) Pub. Date: Jan. 20, 2022

(54) ROBOT MANIPULATOR FOR HANDLING OBJECTS

(71) Applicant: GREY ORANGE PTE. LTD., Singapore (SG)

(72) Inventors: Sumit Kumar Tiwary, Gorakhpur (U.P.) (IN); Mathew Livianu, Malden, MA (US); Sameer Narkar, Mumbai (IN); Shawn Schaffert, Arlington, MA (US); Akash Madhukar Patil, Pune (IN); Jamie Nichol, Carlisle, MA (US); Daniel Echeverria, Cambridge, MA (US); Andreas Hofmann, Boston, MA (US)

(73) Assignee: GREY ORANGE PTE. LTD., Singapore (SG)

(21) Appl. No.: 17/305,922

(22) Filed: Jul. 16, 2021

Related U.S. Application Data
(60) Provisional application No. 63/052,626, filed on Jul. 16, 2020.

(51) Int. Cl. B65H 3/04; B65H 3/08; B65H 3/42

(52) U.S. Cl. CPC B65H 3/047; B65H 3/0833; B25J 15/0616; B65H 2553/42; B65H 3/42

(57) ABSTRACT

A robotic manipulator for handling an object is provided. The robotic manipulator includes a first robotic arm and a first end effector coupled to the first robotic arm. A movement of the first robotic arm orients the first end effector with respect to the object. The robotic manipulator includes a housing, a first conveyor operably coupled to the housing, a second conveyor operably coupled to the housing at an angle with respect to the first conveyor, and a first actuation mechanism. The first and second conveyors are arranged to form a top surface and the bottom surface respectively of a spatula-shaped base. The first actuation mechanism operates the first and second conveyors in one of a first direction and a second direction to manipulate the object. The operation of the first conveyor is independent of the operation of the second conveyor.

### CROSS-REFERENCE TO RELATED APPLICATIONS

This application claims priority to U.S. Patent Provisional Application No. 63/052,626, filed Jul. 16, 2020, the entire contents of which is incorporated herein by reference.

### FIELD

The present disclosure relates generally to object handling, and more particularly, to an apparatus for handling objects in a storage facility.

### BACKGROUND

Modern storage facilities handle a large number of inventory items on a daily basis. Examples of such inventory items may include groceries, apparels, or the like. The storage facilities typically store the inventory items on shelves of storage units, and utilize mobile robots to transport the inventory items or the storage units between various locations in the storage facilities for order fulfilment and/or inventory management. For example, for fulfilment of an order, the mobile robots may transport one or more storage units storing the corresponding inventory items to an operation station in the storage facility. At the operation station, an operator may handle (i.e., pick and put-down) the inventory items for the order fulfilment. Such systems, however, rely on manual intervention of the operators which is time-consuming. Further, manual operationality has limited applicability in a large-scale facility that aims to fulfil a large number of orders within a short duration of time.

Robotic manipulators are widely deployed in the storage facilities to solve the aforementioned problem and to ensure efficient management of the inventory items. However, the robotic manipulators exhibit certain performance drawbacks. For example, when existing end effectors of such robotic manipulators are utilized to handle objects, the robotic manipulators fail to maintain a form factor of the object. Such change in an existing form factor may affect a quality of the object and a storage design of the object. The change in the form factor of the object may also modify an appearance of the object as well as a storage plan of the storage facility. Robotic picking technologies are thus unable to handle such objects while maintaining original form factors of the object (i.e., a form factor in which the object was stored originally) and the rest of the stack.

In light of the foregoing, there exists a need for a reliable solution that prevents deformation of the object when being handled by a robotic manipulator at storage facilities.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

Robotic manipulators and systems for handling objects is provided substantially as shown in, and described in connection with, at least one of the figures and claims. The robotic manipulator includes a first robotic arm and a first end effector coupled to the first robotic arm. A movement of the first robotic arm orients the first end effector with respect to the object for handling of the object. The first end effector includes a housing, a first conveyor, a second conveyor, and a first actuation mechanism enclosed in the housing. The first conveyor is operably coupled to the housing. The second conveyor is operably coupled to the housing at an angle with respect to the first conveyor. The first conveyor and the second conveyor are arranged to form a spatula-shaped base. The first conveyor forms a top surface of the spatula-shaped base and the second conveyor forms a bottom surface of the spatula-shaped base. The first actuation mechanism is configured to operate the first conveyor and the second conveyor in one of a first direction and a second direction to manipulate the object. The operation of the first conveyor is independent of the operation of the second conveyor.

In an embodiment, a system for handling an object is provided. The system includes a robotic manipulator and a control server. The robotic manipulator includes a first robotic arm and a first end effector coupled to the first robotic arm. A movement of the first robotic arm orients the first end effector with respect to the object for handling of the object. The first end effector includes a housing, a first conveyor, a second conveyor, and a first actuation mechanism enclosed in the housing. The first conveyor is operably coupled to the housing. The second conveyor is operably coupled to the housing at an angle with respect to the first conveyor. The first conveyor and the second conveyor are arranged to form a spatula-shaped base. The first conveyor forms a top surface of the spatula-shaped base and the second conveyor forms a bottom surface of the spatula-shaped base. The first actuation mechanism, enclosed in the housing, operates the first conveyor and the second conveyor in one of a first direction and a second direction to manipulate the object. The operation of the first conveyor is independent of the operation of the second conveyor. The control server is configured to detect the object to handled. The control server is further configured to determine a sequence of a plurality of actions to be performed by the robotic manipulator for handling the object. The control server is further configured to control, based on the determined sequence of the plurality of actions, the first robotic arm to orient the first end effector with respect to the object. The control server is further configured to control, based on the determined sequence of the plurality of actions, the first actuation mechanism to operate the first conveyor and the second conveyor in the first direction or the second direction to handle the object.

In an embodiment, the robotic manipulator further includes a second robotic arm and a second end effector coupled to the second robotic arm, wherein the second robotic arm and the second end effector assist the first end effector to handle the object.

In another embodiment, the object is placed separately or included in a stack of a plurality of objects.

In an embodiment, the object is one of a deformable object and a non-deformable object.

In an embodiment, the first end effector includes a roller, coupled to the housing, that transitions between a gripping position and a release position based on the movement of the first conveyor in one of the first direction and the second direction.

In another embodiment, the first end effector includes a third actuation mechanism, enclosed in the housing, that controls the transition of the roller between the gripping position and the release position.

In an embodiment, the first end effector includes a flange that extends from the housing and coupled to the first robotic arm, whereby the first robotic arm rotates the first end effector along a defined number of degrees of freedom.

In another embodiment, the first actuation mechanism includes two or more motors configured to operate the first and second conveyors.

In an embodiment, the first actuation mechanism is configured to operate the first conveyor and the second conveyor at a first speed and a second speed, respectively.

In another embodiment, first ends of the first conveyor and the second conveyor are spaced apart by a threshold distance.

In another embodiment, the robotic manipulator further includes comprising one or more image sensors configured to capture one or more images, wherein the object to be handled is detected based on the one or more images.

In an embodiment, the system for handling the object further includes a database associated with the control server. The control server is further configured to store, upon successful handling of the object, the sequence of the plurality of actions in the database.

In another embodiment, the control server is further configured to determine the sequence of the plurality of actions based on historical data associated with the object. The historical data includes at least one of a set of physical attributes of the object and information associated with previous handling of the object. The set of physical attributes of the object includes at least one of a shape, a size, a weight, a set of dimensions, a count of folds, a depth information, of the object.

In another embodiment, the system for handling the object further includes a storage unit and a mobile robot. The storage unit has a plurality of shelves such that the object is arranged in a stack of a plurality of objects on a first shelf of the plurality of shelves. The mobile robot is configured to transport to the storage unit from a first location to a second location that is within an operational range of the robotic manipulator.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates an exemplary environment of a system for handling an object, in accordance with an exemplary embodiment of the present disclosure;

FIG. 2A is a perspective view of a robotic manipulator of FIG. 1, in accordance with an exemplary embodiment of the present disclosure;

FIG. 2B is perspective view of the robotic manipulator of FIG. 1, in accordance with another exemplary embodiment of the present disclosure;

FIG. 3A is a perspective view of the first end effector of FIG. 1, in accordance with an exemplary embodiment of the present disclosure;

FIG. 3B is a top view of the first end effector of FIG. 1, in accordance with an exemplary embodiment of the present disclosure;

FIG. 3C is a back view of the first end effector of FIG. 1, in accordance with an exemplary embodiment of the present disclosure;

FIG. 3D is a side view of the first end effector of FIG. 1, in accordance with an exemplary embodiment of the present disclosure;

FIG. 3E is a front view of the first end effector of FIG. 1, in accordance with an exemplary embodiment of the present disclosure;

FIGS. 4A-4E, collectively illustrate an exemplary scenario for handling an object by the robotic manipulator of FIG. 1, in accordance with an exemplary embodiment of the present disclosure;

FIG. 5 is a block diagram of the first end effector of the robotic manipulator of FIG. 1, in accordance with an exemplary embodiment of the present disclosure;

FIG. 6 is a block diagram that illustrates the control server of FIG. 1, in accordance with an exemplary embodiment of the present disclosure;

FIGS. 7A-7B, collectively illustrate an exemplary scenario for handling an object, in accordance with another exemplary embodiment of the present disclosure;

FIG. 8 a block diagram that illustrates a system architecture of a computer system for handling object, in accordance with an exemplary embodiment of the disclosure; and

FIGS. 9A-9C, collectively, represent a flow chart that illustrates a process (i.e., a method) for handling a deformable object arranged in a stack, in accordance with an exemplary embodiment of the disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Certain embodiments of the disclosure may be found in disclosed robotic manipulators and systems for handling an object. Exemplary aspects of the disclosure provide robotic manipulator and system for handling an object.

The robotic manipulators and systems of the disclosure provide a solution for handling of objects within a storage facility. The disclosed robotic manipulators and systems allow for handling of the objects while preserving its corresponding form factor (i.e., a contour). The robotic manipulators disclosed herein allow for a precise handling of the objects without disturbing one or more objects present in its vicinity. The robotic manipulators disclosed herein are fast and require significantly less amount of time for handling of the objects. Hence, the robotic manipulators disclosed herein increases a throughput of the storage facility.

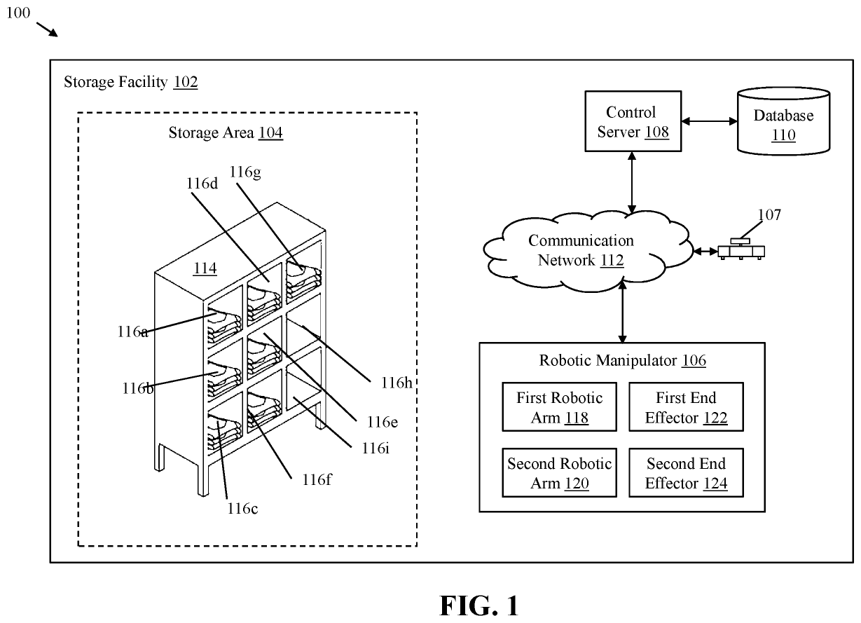

FIG. 1 is a block diagram that illustrates an exemplary environment of a system for handling an object, in accordance with an exemplary embodiment of the present disclosure. Referring to FIG. 1, illustrated is the exemplary environment 100 of the system for handling the object. The environment 100 shows a storage facility 102. The storage facility 102 includes a storage area 104, a robotic manipulator 106, a mobile robot 107, a control server 108, and a database 110. The control server 108 communicates with the robotic manipulator 106 and the mobile robot 107 by way of a communication network 112 or through a separate communication network established therebetween.

The storage facility 102 stores multiple inventory items for order fulfillment and/or selling of one or more inventory items stored in the storage facility 102. Examples of the storage facility 102 may include, but are not limited to, a forward warehouse, a backward warehouse, a manufacturing facility, an item sorting facility, or a retail store (e.g., a supermarket, an apparel store, or the like). The inventory items include objects such as apparels, sheets, cartons, or the like, and are stored in the storage area 104 of the storage facility 102. The storage area 104 may be of any shape, for example, a rectangular shape.

The storage area 104 includes a plurality of storage units (e.g., a storage unit 114) for storing the objects. Examples of the storage unit 114 may include, but are not limited to, multi-tier racks, pallet racks, portable mezzanine floors, vertical lift modules, horizontal carousels, or vertical carousels. In an embodiment, the storage unit 114 may correspond to mobile storage units that are movable from one location to another location in the storage facility 102. In such a scenario, the movement of the storage unit 114 may be enabled by mobile robots (e.g., the mobile robot 107) or any other mechanism known in the art.

The storage unit 114 includes various shelves, and each shelf may be empty or may store the objects separately or collectively in a stack. For example, the storage unit 114 includes first through seventh shelves 116a-116g that store various objects, and eighth and ninth shelves 116h and 116i that are empty. Hereinafter, the shelves 116a-116i of the storage unit 114 are referred to as “the shelves 116”. The shelves 116 may have different shapes, sizes, and dimensions. The storage facility 102 may be marked with various fiducial markers (not shown). Examples of the fiducial markers may include, but or not limited to, barcodes, quick response (QR) codes, radio frequency identification device (RFID) tags, or the like. The mobile robots may be configured to read the fiducial markers.

For the sake of brevity, the storage facility 102 is shown to include the storage unit 114. In other embodiments, the storage facility 102 may include a plurality of storage units having identical or different architecture.

The robotic manipulator 106 may include suitable logic, instructions, circuitry, interfaces, and/or code, executable by the circuitry, for executing various operations, such as handling objects. In an embodiment, the robotic manipulator 106 may be a dual-arm robotic manipulator that handles objects stored separately or arranged in stacks. The robotic manipulator 106 may be configured to execute different object handling operations, such as, pick, hold, grab, transfer, sort, put away, adjust alignment, or reverse put inventory items. For example, the object may be transported from an operation station (i.e., pick-and-put station, PPS) to a shelf of a storage unit. In another example, the object may be transported from a shelf of a storage unit to another shelf of the same storage unit, to a shelf of another storage unit, or to the operation station. The storage unit 114 is transported to a location that is within an operational range of the robotic manipulator 106 by the mobile robots. In one example, the robotic manipulator 106 may be deployed in a vicinity of the operation station.

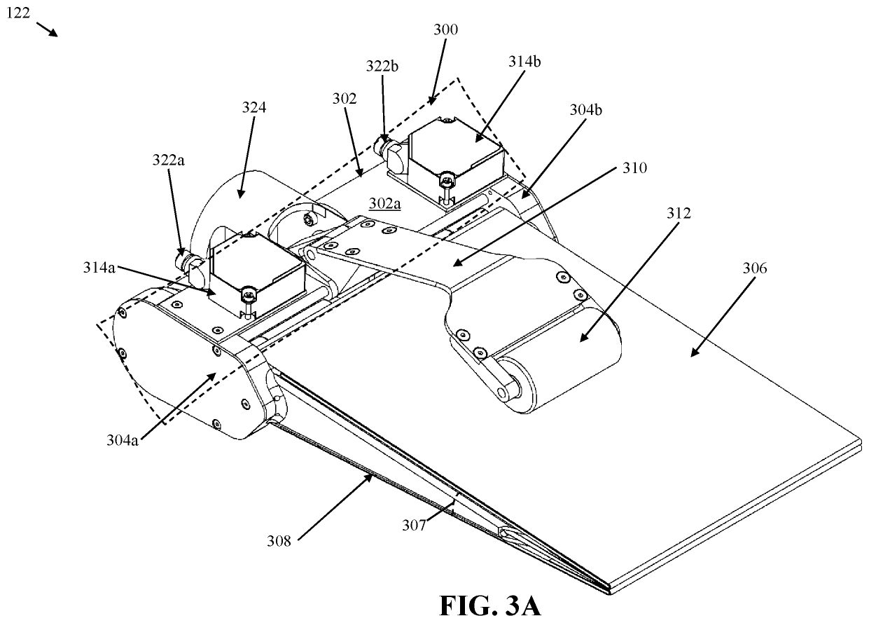

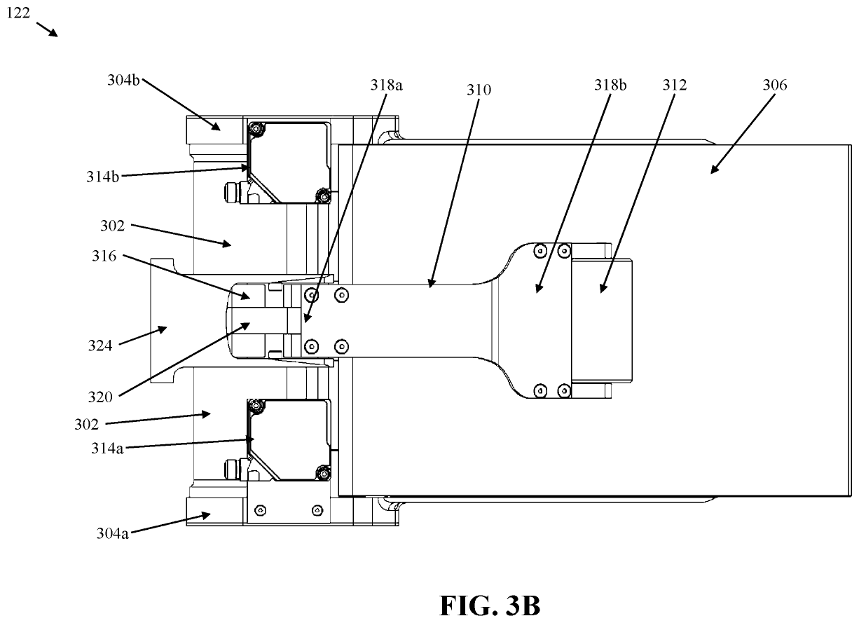

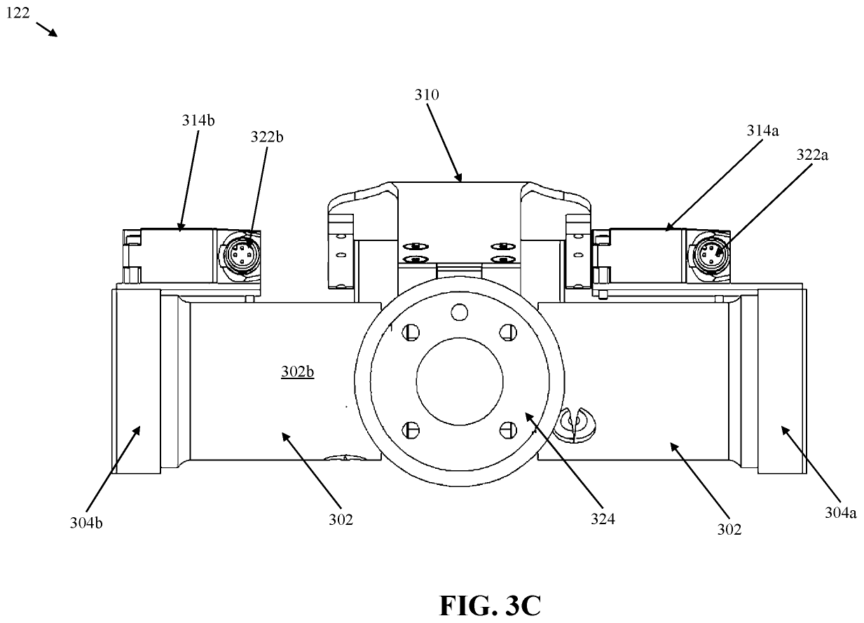

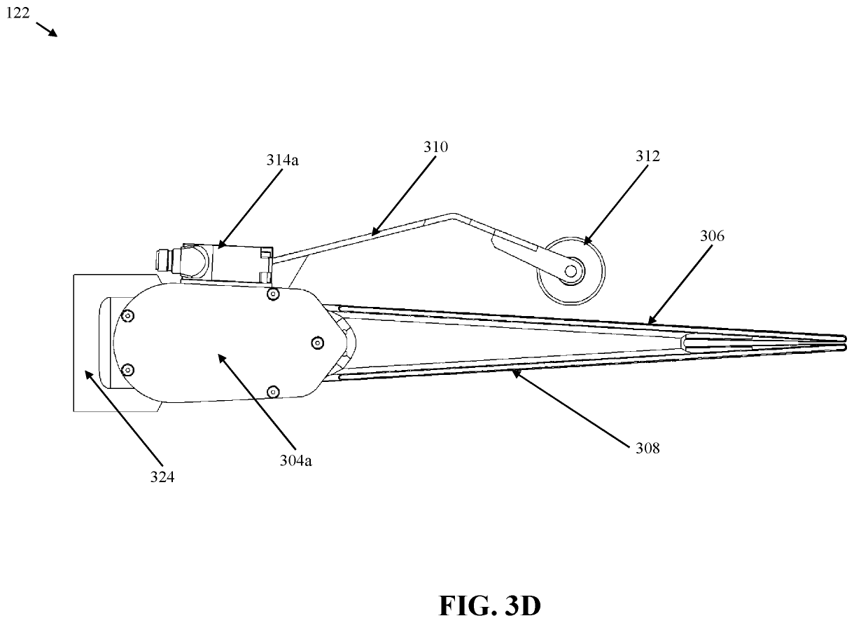

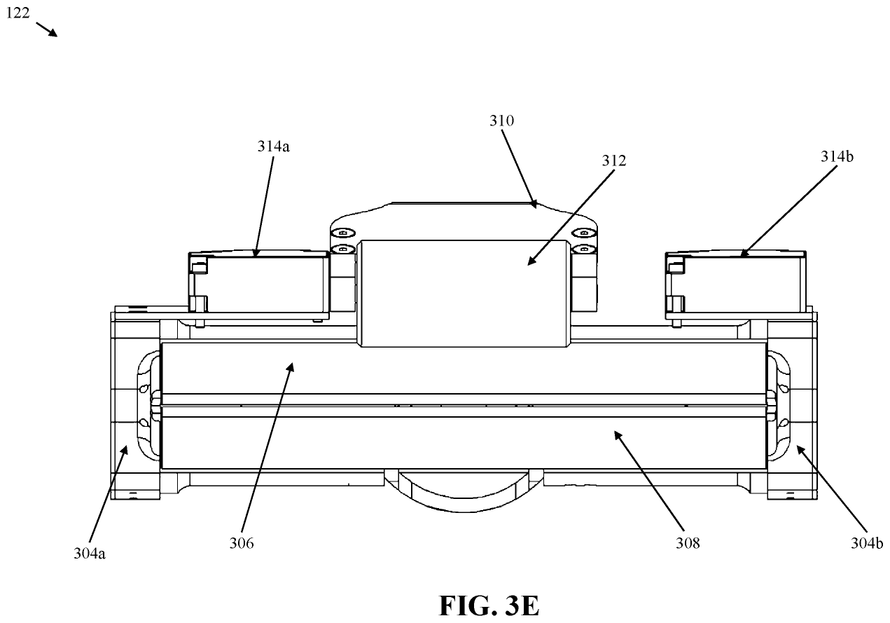

The robotic manipulator 106 includes first and second robotic arms 118 and 120, and a first end effector 122 (i.e., a spatula gripper) and a second end effector 124 coupled to the first and second robotic arms 118 and 120, respectively. The first end effector 122 may further include a flange (shown in FIG. 3C) that rotatably couples the first end effector 122 to the first robotic arm 118 and rotates the first end effector 122 along a defined number of degrees of freedom. A movement of the first robotic arm 118 orients the first end effector 122 with respect to the object for handling of the object. A movement of the second robotic arm 120 orients the second end effector 124 with respect to the object for handling of the object. Orienting the first and second end effectors 122 and 124 refers to positioning the first and second end effectors 122 and 124 with respect to the object in a way that it allows for access and retrieval of the object from its current location thereof.

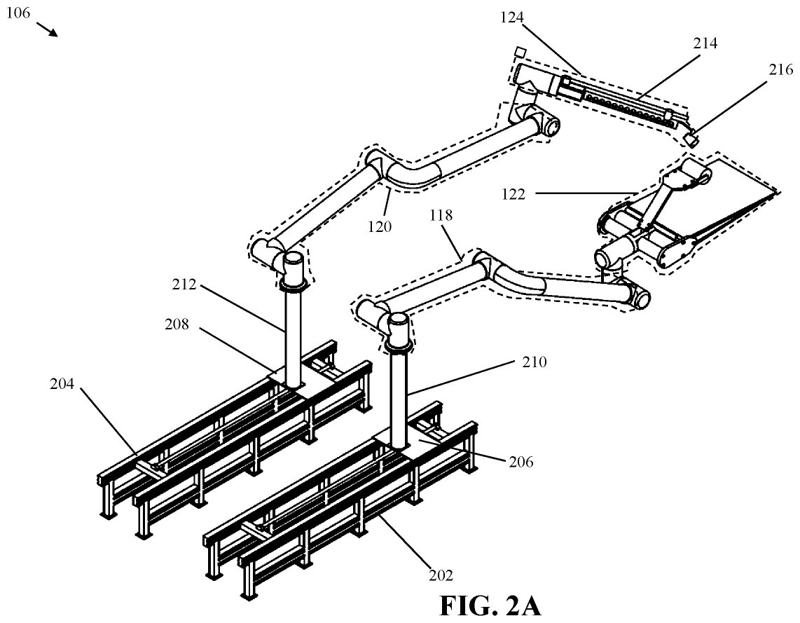

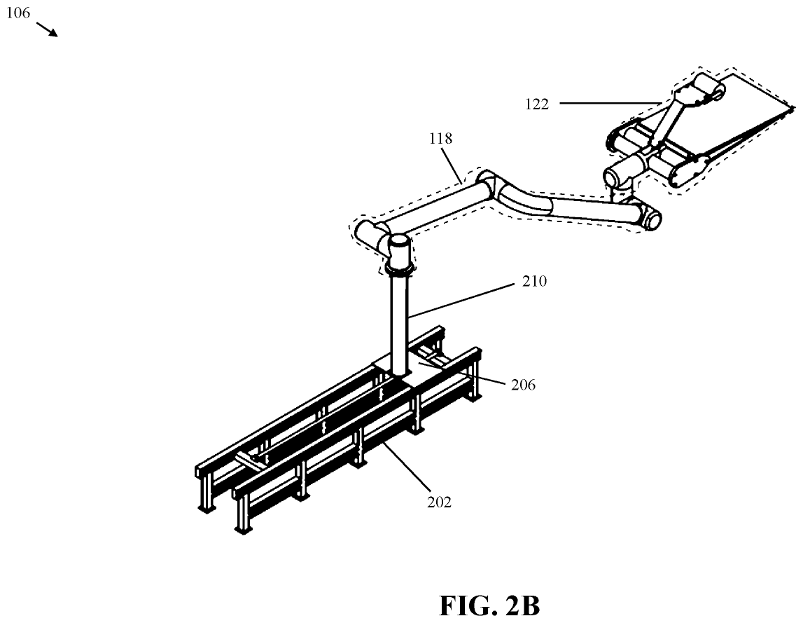

The first end effector 122 may include a housing, a first conveyor (shown in FIG. 3A) operably coupled to the housing, and a second conveyor (shown in FIG. 3A) operably coupled to the housing at an angle with respect to the first conveyor. The first conveyor and the second conveyor are arranged to form a spatula-shaped base. The first conveyor forms a top surface of the spatula-shaped base and the second conveyor forms a bottom surface of the spatula-shaped base. The first conveyor and the second conveyor may be spaced apart by a threshold distance (for example, 0.5 millimeter, 1 millimeter, or the like). The first end effector 122 may further include a first actuation mechanism configured to operate the first conveyor and the second conveyor in one of a first direction and a second direction to manipulate the object. The first actuation mechanism is configured to operate the first conveyor and the second conveyor at a first speed and a second speed, respectively. In an embodiment, the first speed may be different from the second speed. The first actuation mechanism may include two or more electro-mechanical components (for example, motors, rotors, or the like) configured to operate the first and second conveyors. The first actuation mechanism may be enclosed in the housing of the first end effector 122. The operation of the first conveyor is independent of the operation of the second conveyor. In other words, the first actuation mechanism operates the first conveyor and the second conveyor such that a movement of the first conveyor is not affected by a movement of the second conveyor. The first end effector 122 may further include a roller (shown in FIG. 2). The roller is configured to transition between a gripping position and a release position based on the movement of the first conveyor in one of the first direction and the second direction. The first end effector 122 comprises a second actuation mechanism configured to control the transition of the roller between the gripping position and the release position. The second actuation mechanism may be enclosed in the housing of the first end effector 122.

The second end effector 124 may be configured to grip the object to enable the handling of the object by the first end effector 122. In an embodiment, the second end effector 124 may include a vacuum gripper (shown in FIG. 2A) that is configured to grip the object at a gripping end of the object. The gripping end of the object may refer to an outer portion of the object that is accessible to the second end effector 124. The second end effector 124 may be actuated by a third actuation mechanism. The third actuation mechanism may include at least one motor, one or more rotors, or the like configured to move and/or operate the second end effector 124. It will be apparent to a person ordinary skill in the art that the scope of the second end effector 124 is not limited to include the vacuum gripper. In another embodiment, the second end effector 124 can be any end effector that is capable of assisting the first end effector 122 in object handling.

For facilitating the handling of the objects, the robotic manipulator 106 may execute a pick operation on the object, followed by a put-down operation. The pick operation corresponds to gripping and partially lifting the object by way of the second end effector 124, and holding and lifting the partially lifted object in entirety by way of the first end effector 122. The put-down operation corresponds to placing the lifted object at a destination location.

In an embodiment, the robotic manipulator 106 may further include a plurality of image sensors configured to capture one or more images of a vicinity of the robotic manipulator 106 such that the object that is to be handled is detected based on the one or more images. The robotic manipulator 106 may further include a plurality of position sensors configured to detect real-time positions of the first and second robotic arms 118 and 120.

The robotic manipulator 106 may receive various commands from the control server 108 for handling the object, and under control of the received commands, the robotic manipulator 106 may execute the handling of the object. For example, the robotic manipulator 106 may receive various commands from the control server 108 to place an object, arranged in a stack at the platform of the operation station, on a shelf. Under the control of the received commands, the robotic manipulator 106 may pick the object from the stack, and put down the picked object on the shelf. Various components of the robotic manipulator 106 are explained in detail in conjunction with FIGS. 2A and 2B.

The mobile robot 107 is a robotic device (for example, an autonomous mobile robot (AMR), an autonomous guided vehicle (AGV), or a combination thereof) in the storage facility 102. The mobile robot 107 may include suitable logic, instructions, circuitry, interfaces, and/or codes, executable by the circuitry, for automatically transporting payloads (e.g., the storage unit 114) in the storage facility 102 based on commands received from the control server 108. For example, the mobile robot 107 may carry and transport the storage unit 114 from the storage area 104 to the operation station. The mobile robot 107 may include various sensors (e.g., image sensors, RFID sensors, and/or the like) for determining a relative position thereof within the storage facility 102 and/or identifying the storage unit 114.

In some embodiments, the mobile robot 107 may include different functional components, such as a lifting mechanism, an adaptive payload management system, and an autonomous guidance system, by use of which a payload (e.g., a storage unit or an inventory palette) may be moved through different locations in the storage facility 102. The mobile robot 107 may be equipped with suitable components to enable a multi-floor transfer of goods, for example, the mobile robot 107 may move within different floors and fulfil the requirements of the control server 108 by picking different storage units from one floor and transferring it to the operation stations. In addition, the mobile robot 107 may be configured to adapt to different functional parameters, e.g., payload weight, transfer path, cycle time, or the like, in accordance with seamlessly changing of inventory profiles, demand patterns, and order peaks. The storage facility 102 may include multiple mobile robots that may be functionally same or different from each other, with possible variations in payload capacity (in pounds (lbs) or kilograms (Kgs)). For the sake of brevity, the storage facility 102 is shown to include one mobile robot 107. It will be apparent to those of skill in the art that the storage facility 102 may engage any number of transport vehicles without deviating from the scope of the disclosure.

The control server 108 may be a network of computers, a software framework, or a combination thereof, that may provide a generalized approach to create a server implementation. Examples of the control server 108 may include, but are not limited to, personal computers, laptops, mini-computers, mainframe computers, any non-transient and tangible machine that can execute a machine-readable code, cloud-based servers, distributed server networks, or a network of computer systems. The control server 108 may be realized through various web-based technologies such as, but not limited to, a Java web-framework, a .NET framework, a personal home page (PHP) framework, or any other web-application framework.

In some embodiments, the control server 108 is a physical or cloud data processing system on which a server program runs. The control server 108 may be implemented in hardware or software, or a combination thereof. In one embodiment, the control server 108 may be implemented in computer programs executing on programmable computers, such as personal computers, laptops, or a network of computer systems.

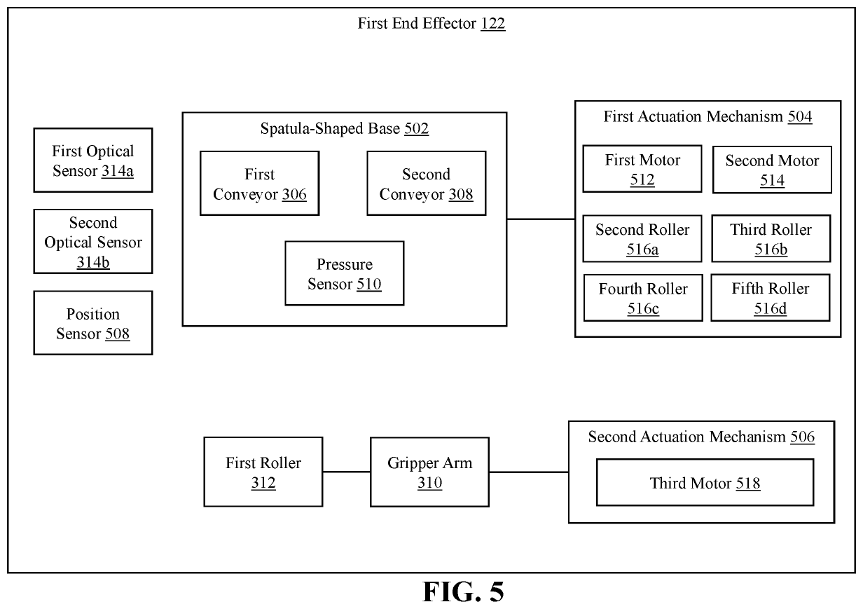

The control server 108 may be configured to implement a goods-to-person (GTP) setup in the storage facility 102, where the storage unit 114 storing different inventory items are picked up from the storage area 104 and transported to the operation station. The control server 108 may be further configured to control execution of different operations associated with replenishment of the storage unit 114, an order sorting operation, palletization and/or de-palletization of inventory items, or the like. The control server 108 may be further configured to determine a sequence of a plurality of actions to be performed by the robotic manipulator 106 for handling the object while performing one or more operations for one of the order fulfillment, the inventory management, or the like. The control server 108 may be maintained by a warehouse management authority or a third-party entity that facilitates inventory management operations for the storage facility 102. Various components of the control server 108 and their functionalities are described later in conjunction with FIG. 5.

In one example, the control server 108 may receive, from a management server at the storage facility 102, a handling request for handling an object that is arranged in a stack. The handling request may be associated with an order fulfilment, an inventory management operation, or the like. The handling request may include a source location of the object, a destination location of the object, fiducial markers of shelves associated with the source and/or destination locations, a unique identifier of the object, or the like. In various other embodiments, the functionalities of the management server may be integrated into the control server 108, without deviating from the scope of the disclosure. In such a scenario, the source and destination locations, the fiducial markers, the unique identifier, or the like, the object to be handled are identified by the control server 108 for the order fulfilment, the inventory management operation, or the like. The control server 108 may communicate the source and destination locations to the robotic manipulator 106.

The database 110 may include suitable logic, instructions, circuitry, interfaces, and/or code to store historical data and a set of commands corresponding to each action in the sequence of actions planned by the control server 108. Examples of the database 110 may include a random-access memory (RAM), a read-only memory (ROM), a removable storage drive, a hard disk drive (HDD), a flash memory, a solid-state memory, and the like. In one embodiment, the database 110 may be realized through various database technologies such as, but not limited to, Microsoft® SQL, Oracle®, IBM DB2®, Microsoft Access®, PostgreSQL®, MySQL® and SQLite®. It will be apparent to a person skilled in the art that the scope of the disclosure is not limited to realizing the database 110 in form of an external database or a cloud storage working in conjunction with the control server 108, as described herein. In other embodiments, the database 110 may be realized in the control server 108, without departing from the scope of the disclosure.

The communication network 112 is a medium (for example, multiple network ports and communication channels) through which content and messages are transmitted between the robotic manipulator 106 and the control server 108. Examples of the communication network 112 may include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 112 in accordance with various wired and wireless communication protocols, such as Transmission Control Protocol and Internet Protocol (TCP/IP), User Datagram Protocol (UDP), Long Term Evolution (LTE) communication protocols, Hypertext Transfer Protocol (HTTP), File Transfer Protocol (FTP), Simple Mail Transfer Protocol (SMTP), Domain Network System (DNS), Common Management Interface Protocol (CMIP), or any combination thereof.

In operation, the control server 108 may receive a handling request. Based on the received handling request, the control server 108 is configured to detect an object that is to be handled. The handling of the object may include picking the object from a first location (for example, top of a first stack) and putting the object at a second location (for example, top of a second stack). The control server 108 may detect the object based on one or more image captured by the plurality of image sensors of the robotic manipulator 106. In an embodiment, the plurality of image sensors may be external to the robotic manipulator 106. The control server 108, based on the detection of the object, may determine a sequence of a plurality of actions to be performed by the robotic manipulator 106 for handling the object. The control server 108 is further configured to communicate the determined sequence of the plurality of actions to the robotic manipulator 106. Based on the received sequence of the plurality of actions, the third actuation mechanism is configured to operate the second end effector 124 to orient the second end effector 124 with respect to the object. The orientation of the second end effector 124 allows the vacuum gripper of the second end effector 124 to grip the object at a gripping end of the object. Upon gripping the object at the gripping end, the second end effector 124 is configured to lift the gripping end of the object to a predetermined height (for example, 1 centimeter, 2 centimeters, or the like). Based on the gripping and lifting of the gripping end of the object, the first actuation mechanism is configured to operate the first end effector 122 to orient the first end effector 122 with respect to the object. The first end effector 122 then slides beneath a lifted surface of the gripping end of the object. Once the first end effector 122 is positioned beneath the lifted surface, the third actuation mechanism is configured to cause the vacuum gripper to release its grip on the gripping end of the object, as a result the lifted surface of the object comes in contact with the first end effector 122. Further, based on such orientation of the first end effector 122, the first actuation mechanism is configured to actuate (or operate) the first and second conveyors to move in a first direction. The first direction may be an anti-clockwise direction of movement of the first and second conveyor. Such movement of the first conveyor allows the object to slide on the top of the spatula-shaped base. Further, movement of the second conveyor in the first direction pushes another object that is placed beneath the object being handled in an opposite direction, and hence prevents the other object from falling or losing a form factor thereof. In an embodiment, the first actuation mechanism may selectively operate the first conveyor at the first speed and the second conveyor at the second speed such that the second speed is less than the first speed.

Thus, FIG. 1 describes a system for handling objects that are arranged in a stack in the storage facility 102. In one embodiment, the system may include only the control server 108 that controls the robotic manipulator 106 for handling the objects in the stack. It will be apparent to a person of ordinary skill in the art that the environment 100 is exemplary and does not limit the scope of the disclosure.

FIG. 2A is a perspective view of the robotic manipulator of FIG. 1, in accordance with an exemplary embodiment of the present disclosure. Referring to FIG. 2A, shown is the robotic manipulator 106. The robotic manipulator 106 includes first and second guide rails 202 and 204 having first and second carriages 206 and 208 mounted thereon, respectively. The first and second carriages 206 and 208 support first and second columns 210 and 212, respectively. The first carriage 206 is affixed at one end of the first column 210 and the first robotic arm 118 is mounted on the opposite end of the first column 210. Likewise, the second carriage 208 is affixed at one end of the second column 212 and the second robotic arm 120 is mounted on the opposite end of the second column 212.

The first and second robotic arms 118 and 120 may include actuators that enable movement of the first and second robotic arms 118 and 120, along a defined number of degrees of freedom, such as six degrees of freedom. The first end effector 122 and the second end effector 124 are tools, assemblies, or apparatus that may be coupled to arm portions at free ends of the first and second robotic arms 118 and 120, respectively. The first end effector 122 and the second end effector 124 may be operated by way of the first actuation mechanism and the third actuation mechanism, respectively.

In one embodiment, the second end effector 124 includes the vacuum gripper that includes a support arm 214 and a suction cup 216 connected to the support arm 214. The suction cup 216 generates vacuum pressure to grip the gripping end of the object to be handled, and the support arm 214 provides support to the suction cup 216. Further, the first end effector 122 acts as the spatula gripper for easy picking and lifting of the object. Various components of the first end effector 122 are explained in detail in conjunction with FIGS. 3A-3E. Although, the second end effector 124, described in conjunction with FIG. 2A, is shown to include the vacuum gripper. It will be apparent to a person skilled in the art that the second end effector 124 is exemplary and in other embodiments, the second end effector 124 may have different structure, components and principle of operation.

The robotic manipulator 106 may further include a movement controller that is connected to the control server 108 for receiving various commands corresponding to various actions that are to be performed by the robotic manipulator 106. The movement of the first and second carriages 206 and 208, the first and second robotic arms 118 and 120, the first end effector 122, the second end effector 124 may be controlled by the movement controller such that the first and second robotic arms 118 and 120 and the first end effector 122 and the second end effector 124 do not collide with each other.

In an embodiment, the robotic manipulator 106 includes a power storage (not shown) configured to store power for one or more operations thereof. Examples of the power storage may include, but are not limited to, a battery, a supercapacitor, or the like.

In another embodiment, the robotic manipulator 106 may include a plurality of wheels, or any other means of movement that enables the robotic manipulator 106 to move from a first location to a second location, within the storage facility 102.

FIG. 2B is perspective view of the robotic manipulator, in accordance with another exemplary embodiment of the present disclosure. Referring to FIG. 2B, shown is the robotic manipulator 106. The robotic manipulator 106 is shown to include the first guide rail 202 having the first carriage 206 mounted thereon. The first carriage supports the first column 210. The first carriage 206 is affixed at one end of the first column 210 and the first robotic arm 118 is mounted on the opposite end of the first column 210. The robotic manipulator 106 described in conjunction with FIG. 2B includes a single robotic arm (i.e., the first robotic arm 118). In an embodiment, the robotic manipulator 106, described in conjunction with FIG. 2B, may handle an object in conjunction with another robotic manipulator that may be similar or different than the robotic manipulator 106.

It will be apparent to a person skilled in the art that the robotic manipulator 106 shown in FIGS. 2A and 2B are exemplary and do not limit the scope of the disclosure. In other embodiments, the robotic manipulator 106 may include one or more additional or different components configured to perform similar or different operations for handling of the object.

FIG. 3A is a perspective view of the first end effector 122, in accordance with an exemplary embodiment of the present disclosure. As shown in FIG. 3A, the first end effector 122 includes the housing (hereinafter, “the housing” is referred to and designated as “the housing 300”) that may be formed in a box-like shape. The housing 300 is shown within a dotted-box. The housing 300 includes a main casing 302, a first side casing 304a, and a second side casing 304b that are assembled together. The main casing 302 includes a top surface 302a, a bottom surface, and a hind surface 302b (shown in FIG. 3C). The top surface 302a, the bottom surface, and the hind surface 302b forms a structure of the main casing 302 that is closed from three sides and open from two sides. The first side casing 304a and the second side casing 304b are concentrically aligned and attached to end portions of the main casing 302. The first and second side casings 304a and 304b act as end caps of two open sides of the main casing 302.

The first end effector 122 includes the first conveyor (hereinafter, “the first conveyor” is referred to and designated as “the first conveyor 306”), the second conveyor (hereinafter, “the second conveyor” is referred to and designated as “the second conveyor 308”), a gripper arm 310, the roller (hereinafter, “the roller” is referred to and designated as “the first roller 312”) attached to the gripper arm 310, and the plurality of image sensors depicted as a first optical sensor 314a and a second optical sensor 314b. The first conveyor 306 and the second conveyor 308 are operatively attached to the housing 300. The first conveyor 306 and the second conveyor 308 are disposed at an angle 307 (i.e., acute angle) between each other to form the spatula-shaped base. The first conveyor 306 forms the top surface of the spatula-shaped base of the first end effector 122. The second conveyor 308 forms the bottom surface of the spatula shaped base of the first end effector 122. The first conveyor 306 includes a conveyor belt that is driven on second and third rollers (shown in FIG. 5). The second conveyor 308 includes another conveyor belt that is driven on fourth and fifth rollers (shown in FIG. 5). The second and fourth rollers may extend longitudinally between the first and second side casings 304a and 304b, and ends of the second and fourth rollers may be encased in the first and second side casings 304a and 304b. In an embodiment, the second and fourth rollers may be disposed within the housing 300. The third and fifth rollers may be disposed at a predetermined distance from the housing 300. The third and fifth rollers may be connected to the housing 300 via an attachment to achieve structural integrity of the first and second conveyors 306 and 308, respectively. In proximity to the third and fifth rollers, the first and second conveyors 306 and 308 may be positioned spaced apart from each other by a minimal distance (i.e., a first threshold distance) to avoid contact therebetween at corresponding first ends. Similarly, in proximity to the second and fourth rollers, the first and second conveyors 306 and 308 may be positioned spaced apart from each other by a maximal distance (i.e., a second threshold distance) at corresponding second ends to form a triangular or V-shaped configuration therebetween (as shown in FIG. 3D).

The second and fourth rollers may be coupled to first and second motors (not shown), respectively. The second and fourth rollers may be engaged with the first and second motors to actively rotate the conveyor belts of the first and second conveyors 306 and 308. In one embodiment, the first and second side casings 304a and 304b may house the first and second motors, respectively. In another embodiment, the main casing 302 may house the first and second motors. In an embodiment, the first and second motors may be induction motors or electric motors. It is apparent to a person skilled in the art that the first and second motors may be coupled to the second and fourth rollers via gear boxes, as is known in the art. In another embodiment, the first motor may alone be used to control the rotation of both the first and second conveyors 306 and 308. The first and second motors may be controlled based on commands from the control server 108 such that the rotating speeds of the first and second conveyors 306 and 308 may be adjusted according to objects encountered in the storage area 104. Typically, the first conveyor 306 may rotate at higher speed than the second conveyor 308. In an instance, the first and second conveyors 306 and 308 may rotate in same direction (i.e., anti-clockwise direction or clockwise direction). In another instance, the first conveyor 306 and the second conveyor 308 may operate in different directions. The anti-clockwise rotation of the first conveyor 306 facilitates the movement of an object onto the first conveyor 306, whereas the anti-clockwise rotation of the second conveyor 308 ensures that remaining objects in a stack are unaffected. Similarly, the clockwise rotation of the first conveyor 306 facilitates placement of a picked object on a desired location, whereas the clockwise rotation of the second conveyor 308 ensures that other objects at the desired location are unaffected during placement.

In an embodiment, the first conveyor 306 and the second conveyor 308 may operate with a same speed of rotation. In another embodiment, the first conveyor 306 and the second conveyor 308 may operate different speeds. In another embodiment, the first conveyor 306 may operate with a non-zero speed and the second conveyor 308 may operate with a zero speed that is to say the second conveyor 308 may not move.

FIG. 3B is a top view of the first end effector 122, in accordance with an exemplary embodiment of the present disclosure. FIG. 3B is described in conjunction with FIG. 3A. Referring to FIG. 3B, the main casing 302 encases an axial member 316 that extends longitudinally between the first and second end casings 304a and 304b. As shown in FIGS. 3A and 3B, the gripper arm 310 having a first end 318a and a second end 318b is secured to the housing 300. The first end 318a of the gripper arm 310 is attached to a coupling member 320. The coupling member 320 is coupled to the axial member 316. The first roller 312 is coupled to the second end 318b of the gripper arm 310. The first roller 312 is oriented parallel to the first conveyor 306. In an embodiment, the first roller 312 may be made of soft materials, such as but not limited to rubber, polymeric material, plastic, or the like. The first roller 312 may transition between the release position and the gripping position. While in the gripping position, the first roller 312 holds the object at a fixed position on the first conveyor 306. The first conveyor 306 does not operate while the first roller 312 is in the gripping position. While in the release position the first roller 312 is positioned away from the first conveyor 306. The first roller 312 remains in release position while the first conveyor 306 operates to perform a pick or put operation for handling the object. The axial member 316 may be connected to a third actuator configured to move (or rotate) the gripper arm 310 to transition the first roller 312 between the gripping position and the release position. The third actuator may be encased in the main casing 302. In an embodiment, the third actuator may be preferably a pneumatically actuated cylinder. In another embodiment, the third actuator may be a servo motor. When the gripper arm 310 is in the release position, the first roller 312 may be positioned at a first predetermined height from the first conveyor 306. When the gripper arm 310 is in the gripping position, the first roller 312 may be positioned at a second predetermined height from the first conveyor 306. The second predetermined height may vary based on shape, size, and dimensions (such as height) of an object that is to be handled. The third actuator may be controlled based on commands from the control server 108 to control the movement of (or maneuver) the gripper arm 310. In the gripping position, the gripper arm 310 and the first roller 312 firmly hold a picked object on the first conveyor 306.

Referring back to FIG. 3A, the first and second optical sensors 314a and 314b may be mounted on the housing 300 of the first end effector 122. The first and second optical sensors 314a and 314b may be used for capturing images of surroundings of the first end effector 122. The first and second optical sensors 314a and 314b may be positioned spaced apart from each other and on either side of the gripper arm 310. It is apparent to a person skilled in the art the first end effector 122 may have only first optical sensor 314a to capture images of surroundings of the first end effector 122. In an embodiment, the first and second optical sensors 314a and 314b may be communicatively coupled to the control server 108 via a wired connection or a wireless connection. The operation of the first and second optical sensors 314a and 314b may be controlled by the control server 108. The first and second optical sensors 314a and 314b capture image of the picked object on the first conveyor 306, and communicate image data corresponding to the lifted object to the control server 108.

The first end effector 122 further includes first and second input/output (I/O) ports 322a and 322b for power supply and wired communication. The first end effector 122 may also include a set of pressure sensors (not shown) coupled underneath the first conveyor 306. The set of pressure sensors records pressure exerted by a lifted object on the first conveyor 306, and communicate pressure data corresponding to the recorded pressure to the control server 108.

In an embodiment, the first end effector 122 further includes a plurality of position sensors configured to detect a position of one of gripper arm 310 and the first roller 312 with respect to the first conveyor 306.

FIG. 3C is a back view of the first end effector 122, in accordance with an exemplary embodiment of the present disclosure. FIG. 3C is described in conjunction with FIGS. 3A and 3B. The first end effector 122 includes the flange (hereinafter, referred and designated as “the flange 324”) that protrudes from peripheral surface of the main casing 302. The flange 324 acts as a mating component that allows the first end effector 122 to attach to the second robotic arm 120. The flange 324 allows the first end effector 122 to rotate along a defined number of degrees of freedom with respect to the first robotic arm 118. Such movement of the first end effector 122 allows for a desired positioning of the first end effector 122 while orienting with respect to the object being handled. Beneficially, the rotations of the first end effector 122 along the defined number of degrees of freedom allows for scooping (i.e., lifting) of the object with a desired orientation with respect to the object.

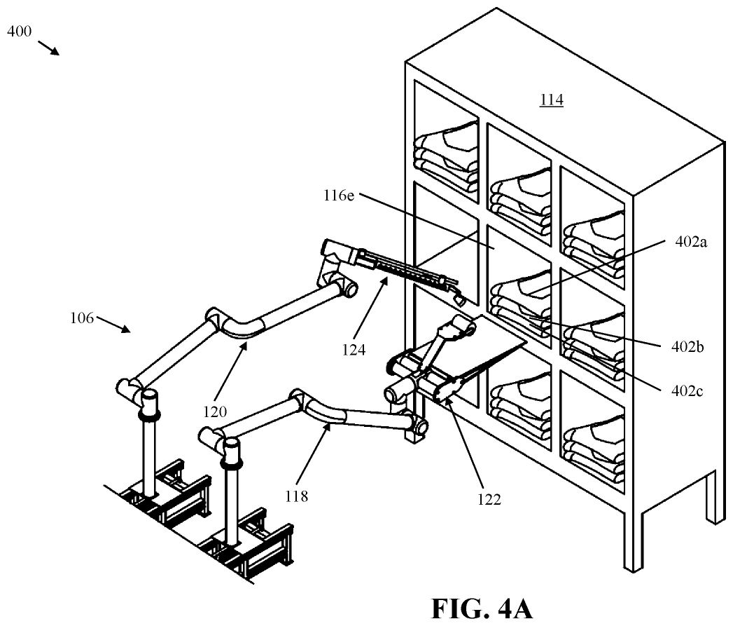

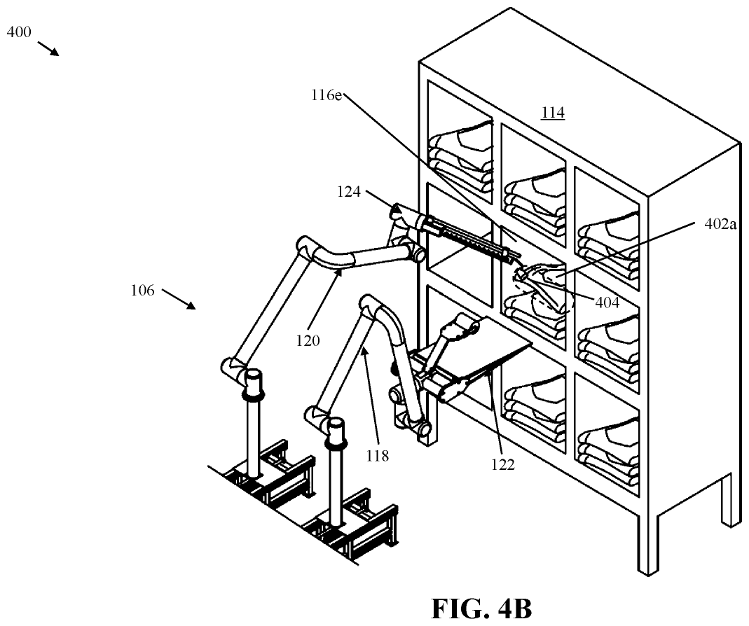

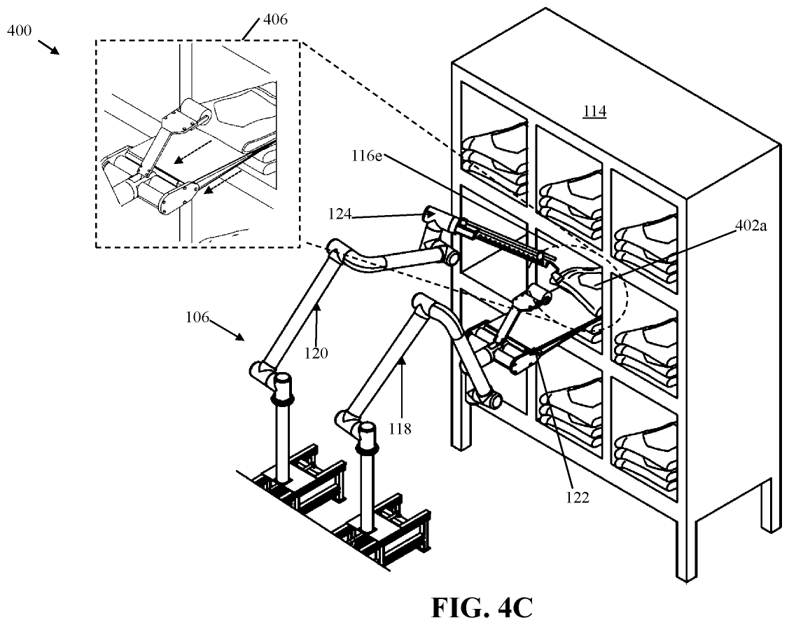

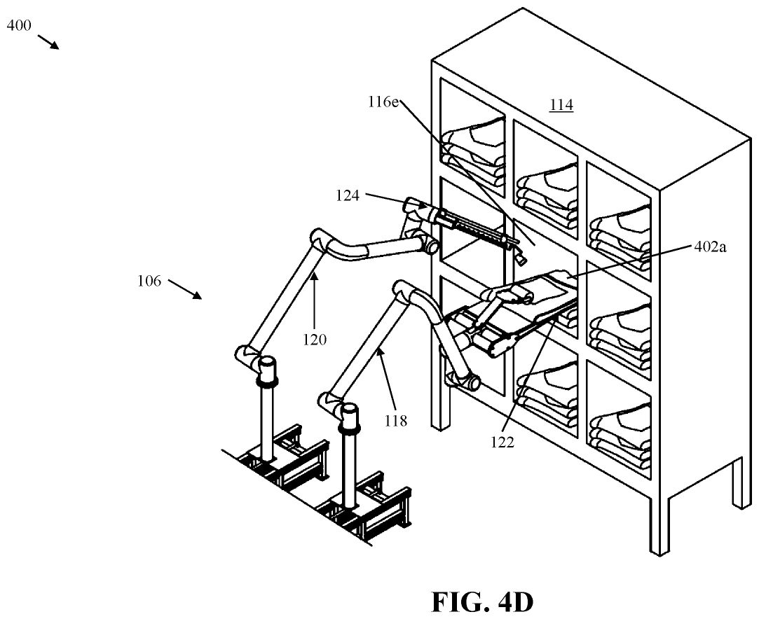

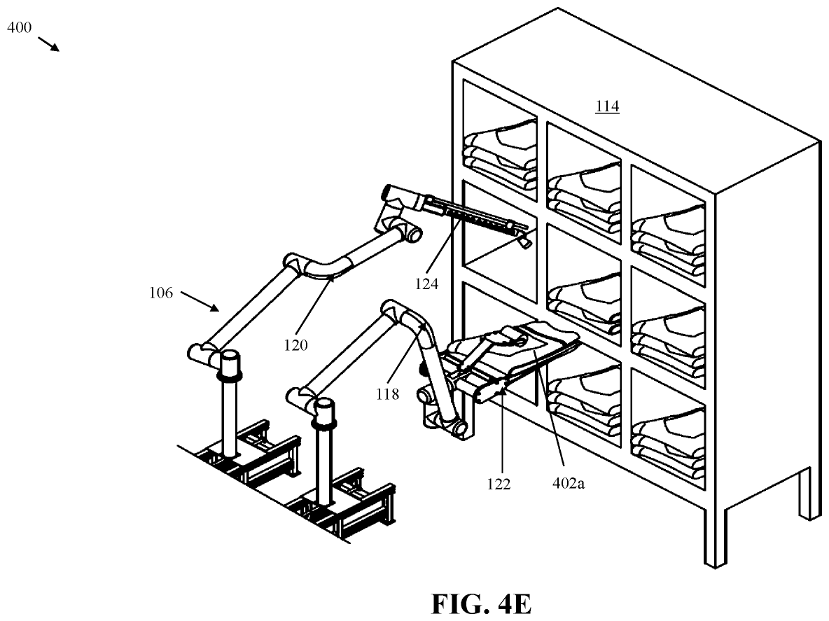

FIG. 3D is a side view of the first end effector 122 of FIG. 1, in accordance with an exemplary embodiment of the present disclosure. FIG. 3E is a front view of the first end effector 122 of FIG. 1, in accordance with an exemplary embodiment of the present disclosure. The operation of the first end effector 122 is explained in detail in conjunction with FIGS. 4A-4E.

FIGS. 4A-4E, collectively illustrate an exemplary scenario 400 for handling an object by the robotic manipulator 106, in accordance with an exemplary embodiment of the present disclosure. In an example, the object to be handled may be included in a stack of a plurality of objects. In another example, the object to be handled may be placed separately and may not be included in a stack. For the sake of ongoing description of FIGS. 4A-4E, it is assumed that the object to be handled arranged in a stack.

Referring to FIG. 4A, in the exemplary scenario 400, the control server 108 (as shown in FIG. 1) may receive the handling request for handling the object that is arranged in a stack. In one embodiment, the object may be on top of the stack. For the sake of brevity, it is assumed that the handling request corresponds to handling a first object 402a (for example, an apparel, a stuffed toy, or the like) in a stack of objects that are arranged on the fifth shelf 116e of the storage unit 114. The stack further includes second and third objects 402b and 402c that are stacked beneath the first object 402a.

Though the first object 402a is shown to be included in a stack of a plurality of objects. In other embodiments, the first object 402a may be placed separately and may not be stacked with other objects. Further, though the first object 402a is shown to be a deformable object. In other embodiments, the first object 402a may be a non-deformable object.

The handling request may be for adjusting the alignment of the first object 402a in the fifth shelf 116e or transporting the first object 402a from a source location in the storage facility 102 to a destination location in the storage facility 102 (e.g., another shelf of the same storage unit, a shelf of another storage unit, the operation station, or the like). The handling request may include the source and destination locations of the first object 402a, fiducial markers associated with the source and/or destination locations, and the unique identifier of the first object 402a. For the sake of brevity, it is assumed that the handling request corresponds to transporting the first object 402a from the fifth shelf 116e of the storage unit 114 to the operation station.

Upon reception of the handling request, the control server 108 may use the mobile robot 107 for transporting the storage unit 114 from a first location in the storage area 104 to a second location that is within the operational range of the robotic manipulator 106 for catering to the handling request. When the storage unit 114 is transported to the second location, the control server 108 may communicate the source and destination locations to the robotic manipulator 106 (i.e., the movement controller). Based on the source location, the movement controller may generate and communicate various control signals for controlling the movement of the robotic manipulator 106 such that the robotic manipulator 106 is oriented in front of the storage unit 114.

Referring now to FIG. 4A, the exemplary scenario 400 illustrates that the robotic manipulator 106 is positioned facing the storage unit 114. The robotic manipulator 106 may additionally include a scanner (not shown) for scanning a tag (not shown) that stores an identifier of the first object 402a. In an embodiment, the tag is attached to the first object 402a. In another embodiment, the tag is attached to the fifth shelf 116e. The identifier obtained from the scanned tag is communicated to the control server 108, and the control server 108 compares the received identifier with the unique identifier of the first object 402a included in the handling request. If the two identifiers do not match, the control server 108 may communicate a first alert notification to an operator device (not shown) of an operator (not shown) located at the operation station. The operator may then manually search for the first object 402a in the storage facility 102, and place the first object 402a at the destination location.

If the two identifiers match, the control server 108 may determine whether the orientation of the first object 402a with respect to the remaining objects 402b and 402c is such that the first object 402a is aligned with the remaining stack (i.e., the second and third objects 402b and 402c). For the sake of brevity, it is assumed that the first object 402a is aligned with the remaining stack. The control server 108 may further retrieve, from the database 110 of the control server 108, historical data (physical attributes of the objects, such as shape, size, weight, number of folds, or the like) associated with the first through third objects 402a-402c. When the control server 108 determines that the first object 402a is aligned with the remaining stack, the control server 108 may plan the sequence of actions to be performed by the robotic manipulator 106 to handle the first object 402a whilst maintaining the original form factors of the first object 402a and the remaining stack. The control server 108 may determine the sequence of the plurality of actions based on the historical data (physical attributes of the objects, such as shape, size, weight, number of folds, or the like) associated with the first object 402a or the first through third objects 402a-402c.

A first action in the sequence of actions may correspond to gripping the first object 402a from the gripping end (shown in FIG. 4B) and lifting the gripping end to the predetermined height. The gripping end is identified by the control server 108 such that the original form factors of the first object 402a and the remaining stack are maintained during the lift. In other words, the gripping end is identified by the control server 108 such that lifting of the first object 402a from the gripping end does not change an appearance or contour of the first object 402a from a folded state to an unfolded state (i.e., a deformed state). In one example, the gripping end is a closed end of a folded object.

If the control server 108 determines that the griping end of the first object 402a is on an end that is opposite to the one facing the robotic manipulator 106, the control server 108 may communicate various commands to the mobile robot 107 to rotate the storage unit 114 such that the gripping end of the first object 402a is facing the robotic manipulator 106. In an embodiment, the robotic manipulator 106 may move or change its position with respect to the storage unit 114 in a way that it faces the gripping end of the first object 402a. The control server 108 may then communicate information associated with the gripping end and a first set of commands corresponding to the first action to the robotic manipulator 106. The control server 108 may additionally communicate grip force and pressure details to the robotic manipulator 106.

Referring now to FIG. 4B, the exemplary scenario 400 illustrates that under the control of the first set of commands, the movement controller may control the second robotic arm 120 (by communicating various control signals) to grip, by way of the suction cup 216, the gripping end (hereinafter referred to and designated as “the gripping end 404”) of the first object 402a and lift the gripping end 404 to the predetermined height. The suction cup 216 may apply the grip force and pressure as communicated by the control server 108 to grip the gripping end 404. As the gripping end 404 is lifted by the second robotic arm 120, the first and second optical sensors 314a and 314b capture various images of the partially lifted first object 402a and the remaining stack, and communicate information corresponding to the captured images (i.e., first and second image data, respectively) to the control server 108. Based on the first and second image data and the historical data, the control server 108 identifies a gap developed between the partially lifted first object 402a and the remaining stack, and determines if the gap is equal to the predetermined height (i.e., whether the gripping end 404 is lifted to the predetermined height). When the control server 108 determines that the gripping end 404 is lifted to the predetermined height, the control server 108 communicates a second set of commands corresponding to a second action in the sequence of actions to the robotic manipulator 106. The second action corresponds to partially sliding the first end effector 122 beneath the partially lifted first object 402a.

Referring now to FIG. 4C, the exemplary scenario 400 illustrates that under the control of the second set of commands, the movement controller controls the first robotic arm 118 to partially slide the first end effector 122 beneath the partially lifted first object 402a. In one embodiment, when the first end effector 122 partially slides beneath the partially lifted first object 402a, the first end effector 122 may come in contact with the second object 402b of the remaining stack.

The control server 108 uses the first and second optical sensors 314a and 314b to determine whether the first object 402a is partially positioned on the first conveyor 306. When the control server 108 determines that the first object 402a is partially positioned on the first conveyor 306, the control server 108 communicates, to the robotic manipulator 106, a third set of commands corresponding to a third action in the sequence of actions. The third action may correspond to the release of the grip of the suction cup 216 on the gripping end 404.

When the control server 108 determines that the gripping end 404 of the first object 402a is released, the control server 108 communicates, to the robotic manipulator 106, a fourth set of commands corresponding to a fourth action in the sequence of actions. The fourth action may correspond to control movement of the first and second conveyors 306 and 308 via the first actuation mechanism. Based on the fourth set of commands, the first actuation mechanism operates one or more motors and/or rotors to rotate the first and second conveyors 306 and 308 in anti-clockwise direction (as shown in enlarged view 406) at variable speeds. The movement of the first conveyor 306 allows the first object 402a to move onto the first conveyor 306. Whereas, the movement of the second conveyor 308 ensures that the form factor of remaining stack (i.e., the second and third objects 402b and 402c) is intact. The control server 108 uses the first and second optical sensors 314a and 314b to determine whether the first object 402a is accurately positioned (i.e., the first object 402a is accurately aligned with respect to the first conveyor 306). When the control server 108 determines that the first object 402a is accurately positioned on the first conveyor 306, the control server 108 communicates, to the robotic manipulator 106, a fifth set of commands corresponding to a fifth action in the sequence of actions. Based on the fifth set of commands, the first and second motors receive a stop signal which causes the first and second conveyors 306 and 308 to come to resting positions.

For the sake of brevity, the robotic manipulator 106 is shown to handle the first object 402a. In other embodiments, the robotic manipulator 106 may handle multiple objects simultaneously. In an example, the robotic manipulator 106 may handle the first, second, and the third objects 402a-402c simultaneously. In such an embodiment, a different end effector may be used instead of the second end effector 124 such that the other end effector is able to partially lift the first, second, and the third objects 402a-402c at the same time, thereby enabling the first end effector 122 to slide partially beneath the bottommost object, i.e., the third object 402c. Subsequently, based on the movement of the first conveyor 306 and the second conveyors 308 as described above, the first, second, and the third objects 402a-402c are transferred onto the first conveyor 306.

In an embodiment, the first object 402a to be handled may be a non-deformable parcel positioned on top of a stack including a plurality of non-deformable parcels. In such an embodiment, the control server 108 may cause the first conveyor 306 to move with the first speed in the first direction. Such movement of the first conveyor 306 may cause the first object 402a to slide on top of the first conveyor 306. Further, the control server 108 may prevent the second conveyor 308 from operating, as operation of the second conveyor 308 may cause deformation of the stack including the plurality of non-deformable objects.

In another embodiment, the control server 108 may cause the first conveyor 306 to operate with the first speed and the second conveyor 308 with the second speed. The first speed may be higher than the second speed. In such an embodiment, a pace of handling the first object 402a may be increased due to high speed of operation of the first conveyor 306. The second conveyor 308 is operated with the second speed to prevent remaining objects such as second and third objects 402b and 402c from losing its form factor and disturbing an arrangement of the stack.

In another embodiment, another end effector that is different from the second end effector 124 may be coupled to the second robotic arm 120. Based an anti-clockwise movement of the first end effector 122, the object may slide on top of the first end effector 122. Further, the object may be placed on a destination location based on a clock-wise movement of the first end effector 122

The sequence of the plurality of actions are shown herein to be received from the control server 108 that is external to the robotic manipulator 106. However, in other embodiments, one or more operations of the control server 108 may be performed by a processing circuitry (not shown) of the robotic manipulator 106.

When the control server 108 determines that the first and second conveyors 306 and 308 are in the resting positions (i.e., stopped), the control server 108 communicates, to the robotic manipulator 106, a sixth set of commands corresponding to a sixth action in the sequence of actions. Based on the sixth set of commands, the control server 108 actuates the third actuator that controls rotation of the axial member 316 to transition the first roller 312 from the release position to the gripping position. The third actuator rotates the axial member 316 to adjust the height of the gripper arm 310 with respect to the first object 402a on the first conveyor 306 such that the first roller 312 is firmly in contact with the first object 402a. In one embodiment, the height of the gripper arm 310 may be adjusted based on dimensions of the first object 402a. For example, if a height of the first object 402a is 10 centimeters (cm), the actuator rotates the axial member 316 to adjust the gripper arm 310 at a height of 10 cm above the first conveyor 306. In another embodiment, the first roller 312 may include one or more pressure and touch sensors. In such a scenario, the actuator may rotate the axial member 316 to adjust the height of the gripper arm 310 until the pressure and touch sensors on the first roller 312 detects a contact with the first object 402a. Thus, the gripper arm 310 with the first roller 312 holds the first object 402a on the first conveyor 306. The first roller 312 assists in maintaining the form factor of the first object 402a when the first object 402a is lifted and moved by the first end effector 122.

When the first conveyor 306 is rotated to accurately position the first object 402a thereon, the one or more pressure sensors may record a pressure exerted by the first object 402a on the first conveyor 306. The control server 108 determines whether the first object 402a is accurately positioned on the first conveyor 306 based on pressure data received from the set of pressure sensors 228.

When the control server 108 determines that the first object 402a is inaccurately positioned, the control server 108 may communicate a second alert notification to the operator device of the operator located at the operation station. The operator may then adjust the positioning of the first object 402a on the first end effector 122, place the first object 402a back in the fifth shelf 116e, or transport the first object 402a to the destination location. Alternatively, when the control server 108 determines that the first object 402a is inaccurately positioned, the first and second robotic arms 118 and 120 may be controlled by the movement controller (based on various commands received from the control server 108) to place the first object 402a back in the fifth shelf 116e, and to release the grip of the suction cup 216 on the first object 402a, respectively. In such an instance, the control server 108 may again communicate the sequence of the plurality of actions to the robotic manipulator 106 to handle the object.

Referring now to FIG. 4D, the exemplary scenario 400 illustrates that under the control of the third set of commands, the hold of the suction cup 216 on the first object 402a has been released. Under the control of the sixth set of commands, the height of the gripper arm 310 has been adjusted such that the first roller 312 firmly holds the first object 402a. The first roller 312 assists in maintaining the form factor of the first object 402a when the first object 402a is moved by the first end effector 122. The robotic manipulator 106 thus successfully completes the pick operation. In one embodiment, upon successful completion of the pick operation, the first robotic arm 118 is disengaged from the handling operation of the first object 402a, and may be utilized for handling another object of the same storage unit or an object of another storage unit that is in queue at the operation station. When the first object 402a is successfully picked up, the control server 108 communicates, to the robotic manipulator 106, a seventh set of commands corresponding to a seventh action in the sequence of actions. The seventh action may correspond to transporting the picked first object 402a to the operation station.

Referring now to FIG. 4E, the exemplary scenario 400 illustrates that under the control of the seventh set of commands, the movement controller controls the first robotic arm 118 to move the first end effector 122 holding the first object 402a away from the fifth shelf 116e. The first end effector 122 may then place the first object 402a at the operation station. The control server 108 may also control the first and second conveyers 306 and 308 and the gripper arm 310 for placing the first object 402a at the operation station. The robotic manipulator 106 thus successfully completes the put-down operation, and thereby successfully handling the first object 402a. In one embodiment, to place the first object 402a at the operation station, the control server 108 may adjust the gripper arm 310 such that the first roller 312 is no longer in contact with the first object 402a. The movement controller may then position the first robotic arm 118 in proximity to stack on which the first object 402a has to be placed. The control server 108 may rotate the first and second conveyors 306 and 308 (i.e., in a clockwise direction) to push the first object 402a on to the stack. Simultaneously, the first robotic arm 118 moves in a backward direction in a way that it allows the object to fall on top of the stack while moving in an outward direction of the first conveyor 306. When the first object 402a is placed on to the stack, the first actuation mechanism may control the first robotic arm 118 to withdraw the first end effector 122 to a home position. The home position may refer to a position of the first end effector 122 that is close to the first column 210 and away from the storage unit 114. The first object 402a is thus successfully transported from the fifth shelf 116e to the operation station.

After the successful handling of the first object 402a, the control server 108 may store the plan information of the planned sequence of actions as feedback in the database 110 to update the historical data associated with the first object 402a and reduce the computation time during the subsequent handling of the first object 402a (or a similar object) that is arranged in a similar stack.

It will be apparent to a person skilled in the art that an object may be transported from a stack arranged on a shelf of a storage unit to another shelf of the same storage unit or from a stack arranged on a shelf of one storage unit to a shelf of another storage unit in a similar manner as described above for transporting the first object 402a as described above. Further, an object may be transported from a stack arranged at the operation station to a shelf of a storage unit in a similar manner as described above for transporting the first object 402a. Further, when the handling corresponds to adjusting the alignment of the first object 402a in the fifth shelf 116e, the first object 402a may be lifted by the first end effector 122 that is oriented parallel to the alignment of the first object 402a. Upon lifting, the orientation of the first end effector 122 may be adjusted such that the first end effector 122 is parallel to the remaining stack. The first end effector 122 may then put-down the first object 402a on top of the second object 402b. The first object 402a is lifted and put-down in a similar manner as described above. In such a scenario, the source and destination locations are same (i.e., the fifth shelf 116e). Additionally, when the handling corresponds to the transport of an object that is misaligned in the stack, the first end effector 122 may lift the misaligned object in the afore-mentioned manner, and put-down the lifted object at the destination location.

Although FIGS. 1 and 4A-4E describe a GTP setup, the scope of the present disclosure is not limited to it. In various other embodiments, the control server 108 may be configured to implement a person-to-goods setup in the storage facility 102, where the robotic manipulator 106 is moved to the first location of the storage unit 114 for executing the pick operation, and then to the destination location (e.g., the operation station) for executing the put-down operation.

FIG. 5 is a block diagram of the first end effector 122, in accordance with an exemplary embodiment of the present disclosure. As shown, the first end effector 122 may include the spatula-shaped base (hereinafter, “the spatula-shaped base” is referred and designated as “the spatula-shaped base 502”), the first actuation mechanism (hereinafter, “the first actuation mechanism” is referred to as and designated as “the first actuation mechanism 504”), the gripper arm 310, the first roller 312, and the second actuation mechanism (hereinafter, “the second actuation mechanism” is referred to and designated as “the second actuation mechanism 506”). The first end effector 122 further includes the first and second optical sensors 314a and 314b and a position sensor 508. The position sensor 508 may be configured to detect a position of the gripper arm 310 and the first roller 312 with respect to the first conveyor 306. The spatula-shaped base 502 includes the first conveyor 306, the second conveyor 308, and the set of pressure sensors such as a pressure sensor 510. As shown, the first actuation mechanism 504 includes the first motor (hereinafter, “the first motor” is referred and designated as “the first motor 512”), the second motor (hereinafter, “the second motor” is referred and designated as “the second motor 514”), the second through fifth rollers (hereinafter “the second through fifth rollers” are referred and designated as “the second through fifth rollers 516a through 516d”). The third actuation mechanism include a third motor 518 configured to operate the gripper arm 310 to transition the first roller 312 between the gripping position and the release position.

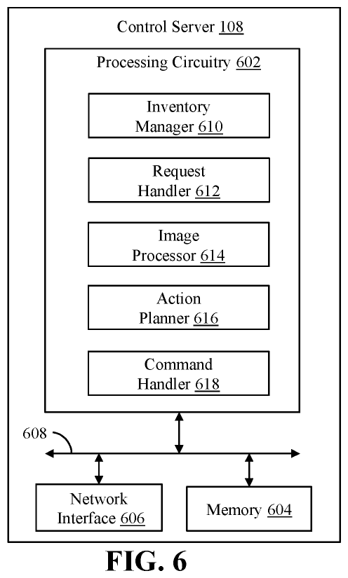

FIG. 6 is a block diagram that illustrates the control server 108, in accordance with an exemplary embodiment of the present disclosure. In some embodiments, the control server 108 may include processing circuitry 602, a memory 604, and a network interface 606 that communicate with each other by way of a communication bus 608. The processing circuitry 602 may include an inventory manager 610, a request handler 612, an image processor 614, an action planner 616, and a command handler 618. It will be apparent to a person having ordinary skill in the art that the control server 108 is for illustrative purposes and not limited to any specific combination or hardware circuitry and/or software.

The processing circuitry 602 executes various operations, such as inventory or warehouse management operations, procurement operations, or the like. The processing circuitry 602 executes the inventory management operations, such as planning the sequence of actions to be performed by the robotic manipulator 106 for handling objects (as described in the foregoing descriptions of FIGS. 4A-4E) and to facilitate transport of the objects whilst maintaining the corresponding original form factor. The processing circuitry 602 executes the inventory or warehouse management operations by way of the inventory manager 610, the request handler 612, the image processor 614, the action planner 616, and the command handler 618.

The inventory manager 610 includes suitable logic, instructions, circuitry, interfaces, and/or code for managing an inventory list that includes a list of objects stored in the storage facility 102, a number of units of each object stored in the storage facility 102, and a source location (i.e., a shelf and/or a storage unit) where each object is stored. For example, the inventory manager 610 may add new objects to the inventory list when the new objects are stored in the storage area 104 and may update the inventory list whenever there is any change in regards to the objects stored in the storage area 104 (e.g., when items are retrieved from the storage unit 114 for fulfilment of orders).

The request handler 612 includes suitable logic, instructions, circuitry, interfaces, and/or code for processing all handling requests received by the control server 108. The request handler 612 may identify objects pertinent to the handling requests, and the shelves 116 that store the objects associated with the handling requests. The request handler 612 may further communicate, for fulfilment of the handling requests, details regarding the objects (such as the source location, the destination location, the fiducial markers, the unique identifiers, or the like) to the robotic manipulator 106. Additionally, the request handler 612 may merge various handling requests when objects to be handled are stored in the same storage unit.

The image processor 614 includes suitable logic, instructions, circuitry, interfaces, and/or code for receiving the first and second image data from the first and second optical sensor 314a and 314b. By utilizing one or more image processing techniques on the first and second image data, the image processor 614 detects length of the first object 402a that is positioned on the first conveyor 306 and identifies the gripping end 404 of the first object 402a that is to be handled. The image processor 614 further identifies the gap developed between the partially lifted first object 402a and the remaining fifth shelf 116e, and determines if the gap is equal to the predetermined height (i.e., whether the gripping end 404 is lifted to the predetermined height).

The action planner 616 includes suitable logic, instructions, circuitry, interfaces, and/or code for planning various actions to be performed by the robotic manipulator 106 and the first end effector 122. For example, the action planner 616 may plan the sequence of actions to be performed by the robotic manipulator 106 and the first end effector 122 to handle the first object 402a whilst maintaining the original form factors of the first object 402a. The control server 108 may plan the sequence of actions in real-time based on data of the first object 402a that is to be handled, and the historical data. The action planner 616 also executes various other operations such as determining whether the orientation of the first object 402a with respect to the remaining stack is such that the first object 402a is aligned with the remaining stack, determining whether the first object 402a is accurately positioned on the first conveyor 306, generating the first through second alert notifications, or the like. The action planner 616 may further store the planned sequence of actions in the memory 604 or the database 110 for future use, e.g., handling the second and third objects 402b and 402c in the fifth shelf 116e.

The command handler 618 includes suitable logic, instructions, circuitry, interfaces, and/or code for generating various commands corresponding to the actions planned by the action planner 616. For example, the command handler 618 generates the first through seventh sets of commands corresponding to the first through seventh actions in the sequence of actions, respectively.

Examples of the inventory manager 610, the request handler 612, the image processor 614, the action planner 616, and the command handler 618 may include, but are not limited to, an application-specific integrated circuit (ASIC) processor, a reduced instruction set computing (RISC) processor, a complex instruction set computing (CISC) processor, a field-programmable gate array (FPGA), a microcontroller, a combination of a central processing unit (CPU) and a graphics processing unit (GPU), or the like.

The memory 604 includes suitable logic, instructions, circuitry, interfaces to store one or more instructions that are executed by the inventory manager 610, the request handler 612, the image processor 614, the action planner 616, and the command handler 618 for performing one or more operations. Additionally, the memory 604 may store the inventory list, the map or the layout of the storage facility 102, or the like. In one embodiment, the information stored in the database 110 may be stored in the memory 604, without deviating from the scope of the disclosure. Examples of the memory 604 may include a RAM, a ROM, a removable storage drive, an HDD, a flash memory, a solid-state memory, and the like.

The network interface 606 transmits and receives data over the communication network 112 using one or more communication network protocols. The network interface 606 may transmit various messages and commands to the robotic manipulator 106 and the first end effector 122 and receive data from the first and second optical sensors 314a and 314b. Examples of the network interface 606 may include, but are not limited to, an antenna, a radio frequency transceiver, a wireless transceiver, a Bluetooth transceiver, an ethernet based transceiver, a universal serial bus (USB) transceiver, or any other device configured to transmit and receive data.

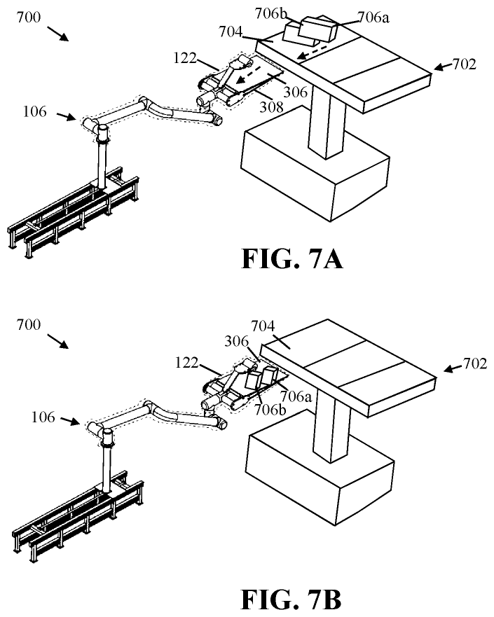

FIGS. 7A-7B, collectively illustrate an exemplary scenario 700 for handling an object, in accordance with an exemplary embodiment of the present disclosure. Referring to FIG. 7A, shown is a mobile robot 702. The mobile robot 702 may include a plurality of conveyors including a third conveyor 704. As shown, fourth and fifth objects 706a and 706b are positioned on top of the third conveyor 704. A direction of movement of the third conveyor 704 is shown by way of a dashed arrow. Further, the robotic manipulator 106 may receive an eighth set of commands from the control server 108 that includes a handling request and indicates identification of the mobile robot 702. Under control of the eighth set of commands, the robotic manipulator 106 identifies the mobile robot 702 by matching the received identifier with an identifier of the mobile robot 702. Based on identification of the mobile robot 702 by the robotic manipulator 106, the control server 108 may determine the sequence of plurality of actions to handle the fourth and fifth objects 706a and 706b. Based on the determined sequence of plurality of actions, the robotic manipulator 106 may orient with respect to the third conveyor 704. The fourth and fifth objects 706a and 706b may move towards the first conveyor 306 based on movement of the third conveyor 704.

Referring to FIG. 7B, when a first portion and/or a second portion of the fourth and fifth objects 706a and 706b, respectively, come in contact with the first conveyor 306, the control server 108 may be configured to communicate a tenth set of instructions to the robotic manipulator 106. Under the control of the tenth set of instructions, the first conveyor 306 may operate in a direction that is identical to a direction of movement of the third conveyor 704 and the second conveyor 308 may remain non-operational. Further, the fourth and fifth objects 706a and 706b may move to the top of the first conveyor 306 based on the operation of the first conveyor 306. When the control server 108 determines that the fourth and fifth objects 706a and 706b are accurately positioned on the first conveyor 306, the control server 108 communicates, to the robotic manipulator 106, an eleventh set of commands. Based on the eleventh set of commands, the first conveyor 306 may come to the resting position. When the control server 108 determines that the fourth and fifth objects 706a and 706b are received successfully by the robotic manipulator 016, the control server 108 communicates a twelfth set of commands to the robotic manipulator 106. Based on the twelfth set of commands, the robotic manipulator 106 may adjust the height of the first robotic arm 118. Further, under the control of the twelfth set of commands, the robotic manipulator 106 may adjust the gripper arm 310 to hold the fourth and fifth objects 706a and 706b in place. Thus, the robotic manipulator 106 completes successful handling of the fourth and fifth objects 706a and 706b.

The control server 108 may further communicate, to the robotic manipulator 106, a thirteenth set of commands that correspond to transporting the picked fourth and fifth objects 706a and 706b to an operation station, a shelf of a storage unit, another mobile robot, or any other destination location. Under the control of the thirteenth set of commands, the movement controller controls the first robotic arm 118 to move the first end effector 122 holding the fourth and fifth objects 706a and 706b away from the mobile robot 702 and towards the operation station, the shelf of the storage unit, or the other mobile robot. The first end effector 122 may then place the fourth and fifth objects 706a and 706b at the operation station, on the shelf of the storage unit, or the other mobile robot. The control server 108 may control the first and second conveyers 306 and 308 and the gripper arm 310 for placing the fourth and fifth objects 706a and 706b at the operation station in a similar manner as described in the foregoing description of FIG. 4E.

The robotic manipulator 106 thus successfully completes the put-down operation, and thereby successfully handling the fourth and fifth objects 706a and 706b.

It will be apparent to a person skilled in the art that handling of object described in conjunction with FIGS. 7A and 7B are exemplary and does not limit the scope of the disclosure.

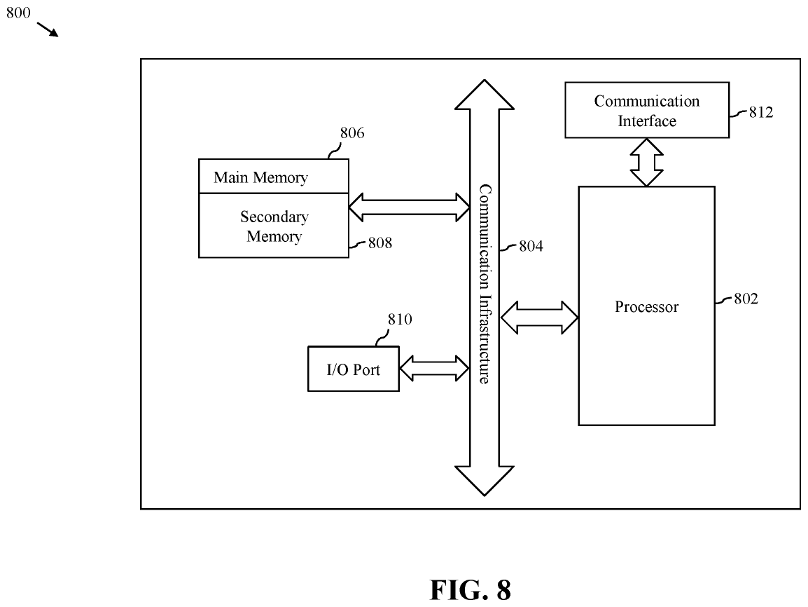

FIG. 8 is a block diagram that illustrates a system architecture of a computer system 800 for handling an object, in accordance with an exemplary embodiment of the disclosure. An embodiment of the disclosure, or portions thereof, may be implemented as computer readable code on the computer system 800. In one example, the control server 108 or the database 110 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the system for handling the object.

The computer system 800 may include a processor 802 that may be a special purpose or a general-purpose processing device. The processor 802 may be a single processor or multiple processors. The processor 802 may have one or more processor “cores.” Further, the processor 802 may be coupled to a communication infrastructure 804, such as a bus, a bridge, a message queue, the communication network 112, multi-core message-passing scheme, or the like. The computer system 800 may further include a main memory 806 and a secondary memory 808. Examples of the main memory 806 may include RAM, ROM, and the like. The secondary memory 808 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The computer system 800 may further include an input/output (I/O) port 810 and a communication interface 812. The I/O port 810 may include various input and output devices that are configured to communicate with the processor 802. Examples of the input devices may include a keyboard, a mouse, a joystick, a touchscreen, a microphone, and the like. Examples of the output devices may include a display screen, a speaker, headphones, and the like. The communication interface 812 may be configured to allow data to be transferred between the computer system 800 and various devices that are communicatively coupled to the computer system 800. Examples of the communication interface 812 may include a modem, a network interface, i.e., an Ethernet card, a communication port, and the like. Data transferred via the communication interface 812 may be signals, such as electronic, electromagnetic, optical, or other signals as will be apparent to a person skilled in the art. The signals may travel via a communications channel, such as the communication network 112, which may be configured to transmit the signals to the various devices that are communicatively coupled to the computer system 800. Examples of the communication channel may include a wired, wireless, and/or optical medium such as cable, fiber optics, a phone line, a cellular phone link, a radio frequency link, and the like. The main memory 806 and the secondary memory 808 may refer to non-transitory computer readable mediums that may provide data that enables the computer system 800 to implement the system for handling the object.

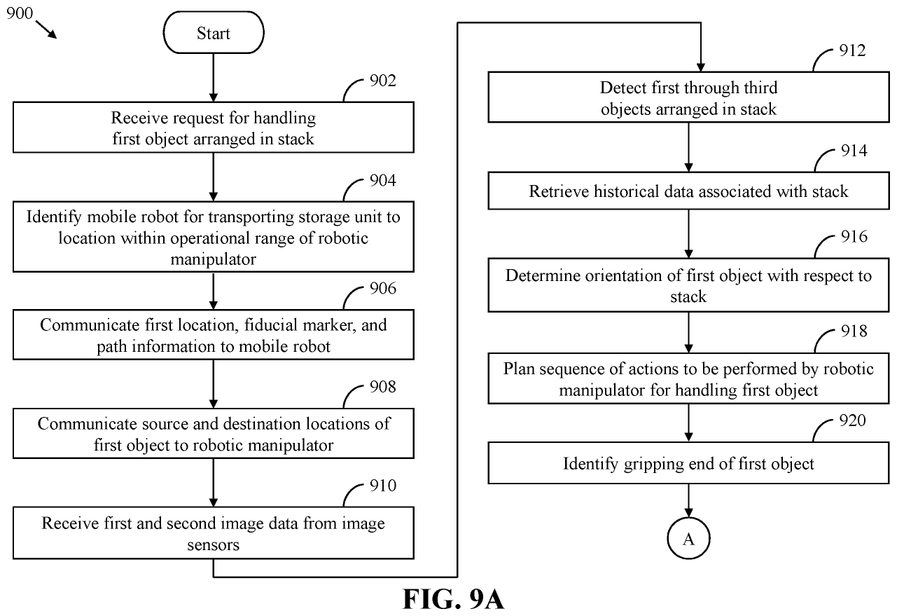

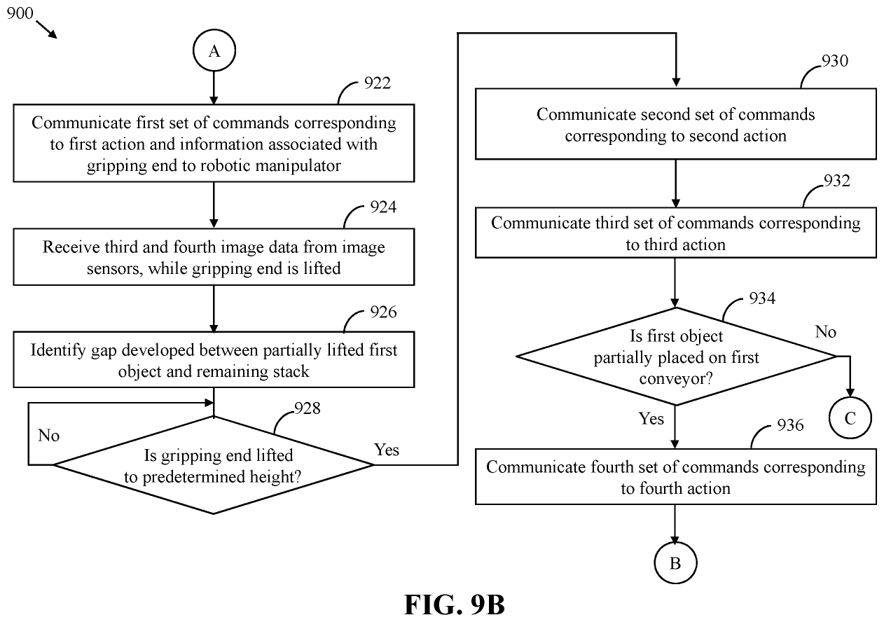

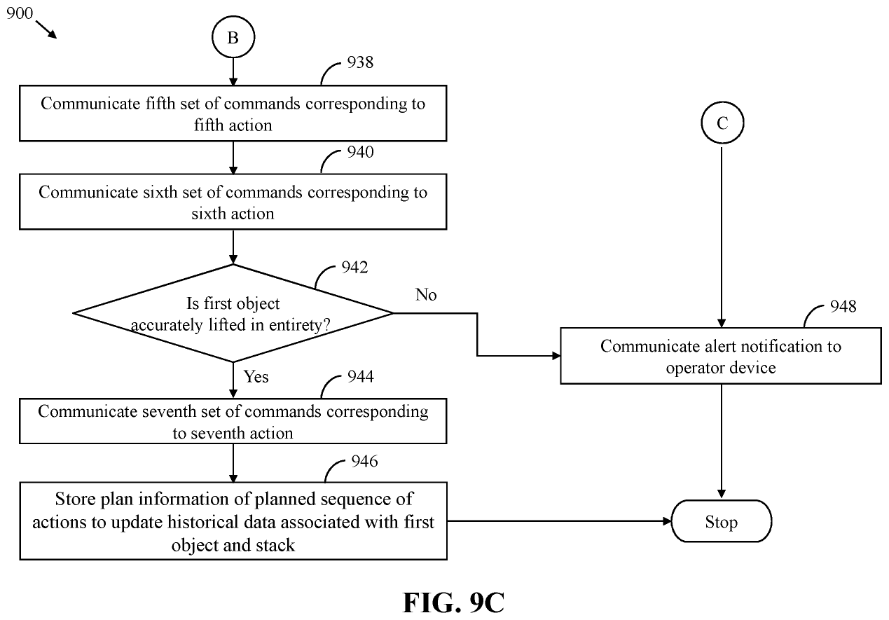

FIGS. 9A-9C, collectively represent a flow chart 900 that illustrates a process (i.e., a method) for handling a deformable object arranged in a stack, in accordance with an exemplary embodiment of the disclosure. Referring now to FIG. 9A, the process may generally start at step 902, where the control server 108 may receive the handling request for handling the object that is arranged in a stack. In one embodiment, the object is on top of the stack. For the sake of brevity, it is assumed that the handling request corresponds to transporting the first object 402a (shown in FIGS. 4A-4E) arranged on the fifth shelf 116e of the storage unit 114 to the operation station. The handling request thus includes the source location as the fifth shelf 116e, the destination location as the operation station, the fiducial marker of the fifth shelf 116e, and the unique identifier of the first object 402a.

The process proceeds to step 904, where the control server 108 may identify the mobile robot 107 for transporting the storage unit 114 from the first location in the storage area 104 to the second location that is within the operational range of the robotic manipulator 106 for catering to the handling request. The identification of the mobile robot 107 may be based on an availability of the mobile robot 107, a proximity of the mobile robot 107 to the storage unit 114, or the like. The process proceeds to step 906, where the control server 108 communicates, to the mobile robot 107, the first location of the storage unit 114, the fiducial marker of the storage unit 114, and a path information of various paths to be followed by the mobile robot 107 to reach the first location from the current location, and from the first location to the second location. The mobile robot 107 may then approach the first location, lift the storage unit 114, and transport the storage unit 114 from the storage area 104 to the second location that is within the operational range of the robotic manipulator 106.

The process proceeds to step 908, where the control server 108 communicates the source and destination locations of the first object 402a to the robotic manipulator 106 (i.e., the movement controller) when the storage unit 114 is transported to the second location. Based on the source location, the movement controller generates and communicates various control signals to the actuators for controlling the movement of the robotic manipulator 106 such that the robotic manipulator 106 is oriented to face the storage unit 114.

The process proceeds to step 910, where the control server 108 receives first and second image data from the first and second optical sensors 314a and 314b. The process proceeds to step 912, where based on the first and second image data, the control server 108 detects the first through third objects 402a-402c arranged in the stack in the fifth shelf 116e.

The process proceeds to step 914, where the control server 108 retrieves the historical data associated with the stack. The control server 108 retrieves, from the database 110, historical data (physical attributes of the objects, such as shape, size, weight, number of folds, or the like) associated with the first through third objects 402a-402c. The process proceeds to step 916, where the control server 108 determines the orientation of the first object 402a with respect to the stack. The process proceeds to step 918, where the control server 108 plans the sequence of actions (i.e., the sequence of the plurality of actions) to be performed by the robotic manipulator 106 for handling the first object 402a. The process proceeds to step 920, where the control server 108 identifies the gripping end 404 of the first object 402a. The process then proceeds to process A as shown in FIG. 9B.

Referring now to FIG. 9B, the process A proceeds to step 922, where the control server 108 communicates the first set of commands corresponding to the first action and information associated with the gripping end 404 to the robotic manipulator 106. The process then proceeds to step 924, where the control server 108 receives third and fourth image data from the first and second optical sensors 314a and 314b, while the gripping end 404 is lifted by the second end effector 124. The process proceeds to step 926, where the control server 108 identifies the gap between the partially lifted first object 402a and the remaining stack. The process proceeds to step 928, where the control server 108 determines whether the gripping end 404 is lifted to the predetermined height (i.e., whether the gap is equal to the predetermined height). If at step 928, the control server 108 determines that the gripping end 404 is lifted to the predetermined height, the process proceeds to step 930. If at step 928, the control server 108 determines that the gripping end 404 is not lifted to the predetermined height, the height of the gripping end 404 is adjusted and step 928 is repeated until the gripping end 404 is lifted to the predetermined height. At step 930, the control server 108 communicates the second set of commands corresponding to the second action to the robotic manipulator 106. The second action corresponds to partially sliding the first end effector 122 beneath the partially lifted first object 402a. The process proceeds to step 932, where the control server 108 communicates the third set of commands corresponding to the third action to the robotic manipulator 106. The third action may correspond to the release of the grip of the suction cup 216 on the gripping end 404. Based on the third set of commands, the third actuation mechanism control the suction cup 216 to release the grip on the gripping end 404.

The process proceeds to step 934, where the control server 108 determines whether the first object 402a is partially placed on the first conveyor 306. If at step 934, the control server 108 determines that the first object 402a is partially placed on the first conveyor 306, the process proceeds to step 936. At step 936, the control server 108 communicates the fourth set of commands corresponding to the fourth action to the robotic manipulator 106. The fourth action may correspond to control movement of the first and second conveyors 306 and 308 via the first actuation mechanism. Based on the fourth set of commands, the first actuation mechanism operates one or more motors and/or rotors to rotate the first and second conveyors 306 and 308 in anti-clockwise direction (as shown in enlarged view 406) at variable speeds. The movement of the first conveyor 306 allows the first object 402a to move onto the first conveyor 306. Whereas, the movement of the second conveyor 308 ensures that the form factor of the remaining stack (i.e., the second and third objects 402b and 402c) is intact. The process then proceeds to process B as shown in FIG. 9C.

Referring now to FIG. 9C, the process B proceeds to step 938, where the control server 108 communicates the fifth set of commands corresponding to the fifth action to the robotic manipulator 106. The fifth action may include stopping a movement of the first and second conveyors 306 and 308. Based on the fifth set of commands, the first and second motors receive the stop signal which causes the first and second conveyors 306 and 308 to come to the resting positions. The process proceeds to step 940, where the control server 108 communicates the sixth set of commands corresponding to the sixth action to the robotic manipulator 106. The sixth action corresponds to transitioning the first roller 312 from the release position to the gripping position. Based on the sixth set of commands, the third actuator controls rotation of the axial member 316 to transition the first roller 312 from the release position to the gripping position. The third actuator rotates the axial member 316 to adjust the height of the gripper arm 310 with respect to the first object 402a on the first conveyor 306 such that the first roller 312 is firmly in contact with the first object 402a. The process proceeds to step 942, where the control server 108 determines whether the first object 402a is accurately lifted in entirety. If at step 942, the control server 108 determines that the first object 402a is accurately lifted in entirety, the process proceeds to step 944. At step 944, the control server 108 communicates the seventh set of commands corresponding to the seventh action to the robotic manipulator 106. The seventh action may correspond to transporting the picked first object 402a to the operation station. The process proceeds to step 946, where the control server 108 stores the plan information of the determined sequence of actions in the database 110 or the memory 604 to update the historical data associated with the first object 402a and the corresponding stack, and reduce the computation time during the subsequent handling of the first object 402a (or a similar object) that is arranged in a similar stack.

If at step 934, the control server 108 determines that the first object 402a is not accurately placed on the first conveyor 306, the process proceeds to step 948. If at step 942, the control server 108 determines that the first object 402a is not accurately lifted in entirety, the process proceeds to step 948. At 948, the control server 108 communicates alert notification to an operator device of the operator. Based on the alert notification, the operator may correct the placement or orientation of the first object 402a on the first conveyor 306.

Techniques consistent with the present disclosure provide, among other features a method and system for handling one or more objects arranged in a stack. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the width or scope.

The robotic manipulator 106 and the system for handling the object disclosed herein provide numerous advantages. The robotic manipulator 106 disclosed herein provides for an easy and swift handling of objects while maintaining a form factor and contour of the corresponding objects. The robotic manipulator 106 disclosed herein does not require any human intervention. Hence, a requirement of manual labor while handling the objects is significantly reduced. Since the first and second conveyors 308 and 308 are operated independently, the robotic manipulator 106 ensures that while handling an object no other objects gets affected. Hence, a probability of causing physical or qualitative damage to other objects while handling the object is significantly reduced. Moreover, a process of handling the object by way of the robotic manipulator 106 is seamless and hence does not fault frequently. The robotic manipulator 106 disclosed herein is robust and portable. The robotic manipulator 106 may significantly increase a throughput of the storage facility 102 by reducing a cumulative time for handling one or more objects while facilitating an order fulfilment as well as while executing inventory management operations. Thus, the handling of the objects as described in the disclosure is more efficient as compared to other known object handling methods.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present disclosure provide, among other features, systems and methods for handling objects in a storage facility using a robotic manipulator. While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

What is claimed is:

1. A robotic manipulator for handling an object, the robotic manipulator comprising:
a first robotic arm; and
a first end effector coupled to the first robotic arm, wherein a movement of the first robotic arm orients the first end effector with respect to the object for handling of the object, and comprising:
a housing;
a first conveyor operably coupled to the housing;
a second conveyor operably coupled to the housing at an angle with respect to the first conveyor, wherein the first conveyor and the second conveyor are arranged to form a spatula-shaped base, and wherein the first conveyor forms a top surface of the spatula-shaped base and the second conveyor forms a bottom surface of the spatula-shaped base; and
a first actuation mechanism, enclosed in the housing, that operates the first conveyor and the second conveyor in one of a first direction and a second direction to manipulate the object, wherein the operation of the first conveyor is independent of the operation of the second conveyor.

2. The robotic manipulator of claim 1, further comprising a second robotic arm and a second end effector coupled to the second robotic arm, wherein the second robotic arm and the second end effector assist the first end effector to handle the object.

3. The robotic manipulator of claim 1, wherein the object is placed separately or included in a stack of a plurality of objects.

4. The robotic manipulator of claim 1, wherein the object is one of a deformable object and a non-deformable object.

5. The robotic manipulator of claim 1, wherein the first end effector further comprises a roller, coupled to the housing, that transitions between a gripping position and a release position for holding the object on the first conveyor or releasing the object positioned on the first conveyor.

6. The robotic manipulator of claim 5, wherein the first end effector further comprises a third actuation mechanism, enclosed in the housing, that controls the transition of the roller between the gripping position and the release position.

7. The robotic manipulator of claim 1, wherein the first end effector further comprises a flange that extends from the housing and coupled to the first robotic arm, whereby the first robotic arm rotates the first end effector along a defined number of degrees of freedom.

8. The robotic manipulator of claim 1, wherein the first actuation mechanism comprises two or more motors configured to operate the first and second conveyors.

9. The robotic manipulator of claim 1, wherein the first actuation mechanism is configured to operate the first conveyor and the second conveyor at a first speed and a second speed, respectively.

10. The robotic manipulator of claim 1, wherein first ends of the first conveyor and the second conveyor are spaced apart by a threshold distance.

11. The robotic manipulator of claim 1, further comprising one or more image sensors configured to capture one or more images, wherein the object to be handled is detected based on the one or more images.

12. A system for handling an object, the system comprising:
a robotic manipulator, comprising:
a first robotic arm; and
a first end effector coupled to the first robotic arm, wherein a movement of the first robotic arm orients the first end effector with respect to the object for handling of the object, and comprising:
a housing;
a first conveyor operably coupled to the housing;
a second conveyor operably coupled to the housing at an angle with respect to the first conveyor, wherein the first conveyor and the second conveyor are arranged to form a spatula-shaped base, and wherein the first conveyor forms a top surface of the spatula-shaped base and the second conveyor forms a bottom surface of the spatula-shaped base; and
a first actuation mechanism, enclosed in the housing, that operates the first conveyor and the second conveyor in one of a first direction and a second direction to manipulate the object, wherein the operation of the first conveyor is independent of the operation of the second conveyor; and
a control server in communication with the robotic manipulator, the control server configured to:
detect the object to be handled;
determine a sequence of a plurality of actions to be performed by the robotic manipulator for handling the object; and
control, based on the determined sequence of the plurality of actions:
the first robotic arm to orient the first end effector with respect to the object; and
the first actuation mechanism to operate the first conveyor and the second conveyor in the first direction or the second direction to handle the object.

13. The system of claim 12, further comprising a database associated with the control server, wherein the control server is further configured to store, upon successful handling of the object, the sequence of the plurality of actions in the database.

14. The system of claim 12, wherein the control server is further configured to determine the sequence of the plurality of actions based on historical data associated with the object, wherein the historical data includes at least one of a set of physical attributes of the object and information associated with previous handling of the object, and wherein the set of physical attributes of the object includes at least one of a shape, a size, a weight, a set of dimensions, a count of folds, a depth information, of the object.

15. The system of claim 12, wherein the robotic manipulator further comprises a second robotic arm and a second end effector coupled to the second robotic arm, and wherein the second robotic arm and the second end effector assist the first end effector to handle the object.

16. The system of claim 12, wherein the object is one of a deformable object and a non-deformable object.

17. The system of claim 12, wherein the first end effector further comprises:
a roller, coupled to the housing, that transitions between a gripping position and a release position for holding the object on the first conveyor or releasing the object positioned on the first conveyor; and
a third actuation mechanism, enclosed in the housing, that controls the transition of the roller between the gripping position and the release position.

18. The system of claim 12, wherein the first end effector further comprises a flange that extends from the housing and coupled the first robotic arm and, whereby the first robotic arm rotates the first end effector along a defined number of degrees of freedom.

19. The system of claim 12, wherein the first actuation mechanism comprises two or more motors configured to operate the first and second conveyors, and wherein the first actuation mechanism is configured to operate the first conveyor and the second conveyor at a first speed and a second speed, respectively.

20. The system of claim 12, further comprising:
a storage unit that has a plurality of shelves, wherein the object is arranged in a stack of a plurality of objects on a first shelf of the plurality of shelves; and
a mobile robot that is configured to transport to the storage unit from a first location to a second location that is within an operational range of the robotic manipulator.
